(19) United States
(12) Patent Application Publication
(10) Pub. No.: US 2009/0035443 A1
(43) Pub. Date: Feb. 5, 2009

(54) PROCESS FOR PRODUCING BEAN CURD SKIN, BEAN CURD SKIN, BEAN CURD SKIN PICKING TOOL AND BEAN CURD SKIN PRODUCING KIT

(75) Inventor: Eiji Kojima, Kanagawa (JP)

Correspondence Address: PROCOPIO, CORY, HARGREAVES & SAVITCH LLP, 530 B STREET, SUITE 2100, SAN DIEGO, CA, 92101, US

(73) Assignee: THE NISSHIN OILLIO GROUP, LTD., Chuo-Ku, Tokyo 104-8285 (JP)

(21) Appl. No.: 11/817,125

(22) PCT Filed: Feb. 6, 2006
(86) PCT No.: PCT/JP2006/301996

§ 371 Date: Aug. 24, 2007

(30) Foreign Application Priority Data
Feb. 25, 2005 (JP) 2005-051561
Jun. 14, 2005 (JP) 2005-173198
Feb. 6, 2006 (JP) PCT/JP2006/301996

(51) Int. Cl. A23L 1/20; A23P 1/10; A23J 3/16; A23J 3/18

(52) U.S. Cl. 426/634; 426/517; 99/450.2; 99/646 LS

(57) ABSTRACT

A process for producing a bean curd skin that enables anyone to easily produce a good-looking monolayer or multilayer bean curd skin, shortening time consumed in the relevant work, and that excels from the hygienic viewpoint. A monolayer or multilayer bean curd skin is produced by a process comprising the thin-film forming step of heating soymilk or the like to thereby form a thin film at the surface thereof; the thin-film sticking step of providing a picking tool with planar part and bringing the planar picking step of pulling up the picking tool having the thin film stuck thereto to thereby accomplish picking of the thin film, these thin-film forming step, thin-film sticking step and thin-film picking step as one cycle repeated one or more times.

### CROSS REFERENCE TO RELATED APPLICATION

Under 35 U.S.C. Section 119, this application is based upon and claims the benefit of prior PCT Application No. PCT/JP2006/301996, filed on Feb. 6, 2006, which is based upon and claims the benefit of prior Japanese Patent Application Nos. 2005-051561 and 2005-173198, filed on Feb. 25, 2005 and Jun. 14, 2005, respectively, the entire contents of which are incorporated herein by reference.

### BACKGROUND OF THE INVENTION

1. Technical Field

The present invention relates to process for producing bean curd skin that comprise taking up thin films formed at the surface of heated bean extracts, bean curd skin, devices for taking up bean curd skin, and kits for producing bean curd skin.

2. Background Art

Bean curd skin (yuba) is popular in Japan as a traditional food and has been favored widely from long ago. Bean curd skin is a food produced by scooping films formed at surface of heated bean extract and a food of thin films formed in a process wherein the protein etc. in bean extract floats and solidifies. Tofu is a high quality plant protein and is also as a widely familiar food for Japanese; bean curd skin along with the tofu have been attracting attention as a healthy food that abundantly includes high quality proteins and plant fats contained in soybeans while interest in health has been growing in recent years.

However, it has been difficult for ordinary people to take up such bean curd skin because this requires experience and skill. The step to overlap the resulting films of bean curd skin to produce multilayer bean curd skin also requires similarly a considerable amount of experience and skill, thus it has been difficult for ordinary people to produce good-looking bean curd skin.

The process for taking up bean curd skin is typically carried out by grasping and raising the ends of bean curd skin (point-grasping process) or by immersing rods such as bamboo skewers under thin films of bean curd skin followed by scooping and making a folio (line-scooping process). However, the processes for taking up bean curd skin by use of points or lines sometimes cause cuts at taking up the bean curd skin or damage the bean curd skin when immersing the rods such as bamboo skewers under thin films of bean curd skin, thus it has been difficult to simply produce neat bean curd skin for most people.

In order to solve the problem described above, Japanese Unexamined Patent Application Publication No. Hei 07-1.94332 discloses a method for producing bean curd skin, in which a device for scooping the bean curd skin is preliminary inserted before a thin film of bean curd skin is formed at the surface of bean extract, and the device for scooping the bean curd skin is raised after the thin film forms at the surface of bean extract (see Patent Document 1).

Patent Document 1: Japanese Unexamined Patent Application Publication No. Hei 07-194332

### DISCLOSURE OF THE INVENTION

### Problems to be Solved by the Invention

Patent Document 1 may solve the problem described above to some extent; however, the bean curd skin is taken up in a folio condition because of it is scooped with a taking up device having a linear scooping portion. Therefore, in order to obtain a laminate of bean curd skin in a condition that plural films are overlapped, a removing step is necessary for removing the taken up bean curd skin from the taking up device then the removed bean curd skin is overlapped in series similarly to conventional production methods for producing the bean curd skin, and the step must be carried out plural times, which leads to complicated production steps, time consuming operations, and low efficiency. In addition, the scooping device described in Patent Document 1 needs to have a certain size in order to assure the area of the resulting bean curd skin, thus is inadequate for domestic application. That is, the method described in Patent Document 1 has not attained yet the simple production of multilayer bean curd skin available to ordinary people nor the production of sufficiently neat bean curd skin.

The present invention has been made in light of the problems described above; it is an object of the present invention to provide a method for producing bean curd skin, whereby neat bean curd skin can be produced simply by anyone without cuts or damage when taking up the bean curd skin; the taking up step and the overlapping step can be carried out simultaneously without a removing step to remove the bean curd skin from a taking up device, thus neat multilayer bean curd skin can be easily produced industrially and domestically; and the method for producing bean curd skin is sanitarily excellent due to shorter operation time and fewer production steps.

### Means for Solving the Problems

The present inventor has researched diligently, with attention focused on taking up by use of a surface rather than a point or a line in order to solve the problems described above. As a result, it has been found that when thin films of bean curd skin are taken up as a surface by use of a taking up device with a face portion, neat bean curd skin can be produced simply by anyone without cutting or damaging the bean curd skin; the taking up step and the overlapping step can be carried out simultaneously, thus neat multilayer bean curd skin can be easily produced without a removing step to remove the bean curd skin from a taking up device; and sanitarily excellent laminates of bean curd skin can be obtained due to shorter operation times and fewer production steps, thus the present invention has been completed. More specifically, the present invention provides the following:

The first aspect of the invention is a method for producing bean curd skin, in which the bean curd skin is taken up as a thin film formed at a surface of heated bean extract, comprising a step of forming a thin film, in which bean extracts are heated to form a thin film on the surface, a step of attaching the thin film, in which a face portion of a taking up device is contacted as a surface with the thin film thereby to make the face portion attach to the thin film, and a step of taking up the thin film, in which the thin film is taken up by pulling up the taking up device with the thin film attached, in which one cycle of the step of forming a thin film, the step of attaching the thin film, and the step of taking up the thin film is repeated for one or more cycles to form monolayer or multilayer bean curd skin.

In the method for producing bean curd skin according to the first aspect, the bean curd skin formed as a thin film is taken up by a face portion rather than a point or a line. In the conventional methods to clip by a stick (line) or hand (point), usually, an insert is placed between the thin film and the vessel, the bean curd skin is taken up, followed by separating the stick or hand from the thin film. In contrast, the present invention makes use of a taking up device with a face portion, thus such handling is almost unnecessary, or if necessary, the thin film can be separated merely by shaking a little the taking up device after attaching to the face portion. Therefore, the taking up procedures can be carried out without cutting or damaging the bean curd skin, and anyone can simply produce neat bean curd skin. In addition, since the taking up step and the overlapping step can be carried out simultaneously, neat multilayer bean curd skin can be produced without the step to detach the taken up bean curd skin from the taking up device; and also a laminate of bean curd skin can be obtained with excellent hygiene due to the shorter time necessary for the procedure and the smaller number of production steps.

In addition, multiple repetitions of this cycle can produce plural films of bean curd skin and overlap them without the step to detach the taken up bean curd skin from the taking up device, that is, while maintaining the condition that the bean curd skin taken up by the face is disposed on the face portion of the taking up device. Therefore, the laminate of bean curd skin can be efficiently produced.

The second aspect of the invention is the method for producing bean curd skin according to the first aspect, wherein the area of the face portion of the taking up device is smaller than the area of the thin film.

In accordance with the method for producing the bean curd skin of the second aspect, the difference in areas between the face portion of the taking up device (area to contact the bean curd skin) and the open face of the bean extract-injecting container (area of the bean curd skin) is utilized to produce a bean curd skin of which the peripheral margin is folded inside (toward bean extracts). The bean curd skin of which the peripheral margin is folded inside has a complex structure wherein the bean extracts (liquid) is interposed in the spaces of the overlapped peripheral margins and also the outside is thicker and the inside is thinner, and therefore, can provide a different eating feel from a sheet of bean curd skin between the central portion and the peripheral margin, thus can provide a complex eating feel and flavor for the entire bean curd skin on eating. Moreover, the folding is carried out automatically upon pulling up the taking up device, therefore, neat bean curd skin can be produced easily with shorter operating times, the bean curd skin does not have to be contacted by hand, which is also sanitarily preferable. In addition, the surface portion of the taking up device (area to contact the bean curd skin) must contact the open face of the bean extract-injecting container, thus the area of the former is, of course, somewhat smaller than the area of the open face of the bean extract-injecting container; in order to achieve the effect, the size is intentionally made small in the present invention.

In addition, adjustment of the difference of areas between the face portion of the taking up device (area to contact with the bean curd skin) and the open face of the bean extract-injecting container (area of the bean curd skin) may allow to employ variation-rich folding styles, for example, three-folded bean curd skin, five-layer structure of bean curd skin, etc. can be easily produced.

The third aspect of the invention is the method for producing bean curd skin according to the first or second aspects, wherein a step of disposing an ingredient is further carried out to dispose the ingredient on the thin film formed at the surface of the heated bean extracts between the step of forming a thin film and the step of attaching the thin film, when forming any layer from the second or later layer of the multiple layers.

In the method for producing the bean curd skin according to the third aspect, one cycle of the step of forming a thin film, the step of attaching the thin film, and the step of taking up the thin film is repeated for one or more cycles to form a multilayer bean curd skin, and the step of disposing an ingredient to dispose the ingredient on the thin film formed at the surface of the heated bean extracts is carried out between the step of forming a thin film and the step of attaching a thin film, upon forming any layer after the second layer. In accordance with this invention, an independent step of disposing an ingredient is unnecessary, and ingredients can be interposed in a series of steps to produce laminates of bean curd skin. Therefore, ingredients can be easily interposed, and also a selection of various ingredients allows to the production of variation-rich laminates of bean curd skin containing the ingredients.

The fourth aspect of the invention is the method for producing bean curd skin according to any one of the first to third aspects, further comprising a step of packaging, wherein a detachable detaching sheet is mounted on the face portion of the taking up device, the detaching sheet is made to attach to the thin film in the step of attaching the thin film, and the detaching sheet with the thin film attached is directly utilized as a part of packaging material in the step of packaging.

In accordance with the fourth aspect of the invention, since the thin film of bean curd skin is attached to the detachable sheet, the bean curd skin can be easily detached from the taking up device by way of removing the detaching sheet. Therefore, the bean curd skin formed on the detaching sheet can be easily processed after removing the sheet. In addition, the usage of the detaching sheet can prevent the taking up device from fouling; and the step of packaging the bean curd skin by use of the detaching sheet as a part of the package material leads to a direct use of the detaching sheet, to which the bean curd skin attaches, as a packaging material, which making it possible to produce a packaged bean curd skin with a simple packaging step.

The fifth aspect of the invention is the method for producing bean curd skin according to any one of the first to fourth aspects, further comprising a step of peeling the thin layer, wherein a peeling guide to peel the monolayer or multilayer bean curd skin from the taking up device is preliminarily mounted on at least a part of the vicinity of the periphery of the face portion of the taking up device, the face portion having the peeling guide is made to attach to the thin film in the step of attaching the thin film, and the thin film is then peeled from the face portion by way of separating the peeling guide from the taking up device or the taking up sheet, in the step of peeling the thin layer.

In accordance with the fifth aspect of the invention, the monolayer or multilayer bean curd skin can be easily peeled from the taking up device starting from the peeling guide, by way of only the portion of the peeling guide, to which the thin film attaches, is separated from the taking up device or the detaching sheet.

The sixth aspect of the invention is the method for producing bean curd skin according to any one of the first to fourth aspects, further comprising a step of peeling the thin layer, wherein the face portion of the taking up device is formed by way of connecting two or more separable parts, the face portion is made to attach to the thin film in the step of attaching the thin film, and the thin film is then peeled from the face portion by way of separating the two or more separable parts, in the step of peeling the thin layer.

In accordance with the method for producing bean curd skin according to the sixth aspect, the thin film attached to the face portion is previously floated (peeled) at only one of two or more parts of the taking up device; then the other part(s) is separated thereby the bean curd skin can be easily peeled from the taking up device. That is, the bean curd skin can be peeled from the taking up device without use of a peeling sheet, which leading to labor savings and increased speed of operation.

The seventh aspect of the invention is the method for producing bean curd skin according to any one of the first to sixth aspects, wherein the step of forming a thin film is carried out by use of an electric oven.

In accordance with the method for producing bean curd skin according to the seventh aspect, the step of forming the thin film is carried out by use of an electric oven. The electric oven is “a cooking apparatus to heat foods by way of irradiating a radio-frequency electromagnetic wave” and generally refers to overall apparatuses to heat foods by way of irradiating a microwave of a wavelength of 2450 MHz. The process for irradiating the microwave may be batch or continuous. Examples thereof include household electric ovens, high output commercial electric ovens, and industrial microwave heating apparatuses.

Since the bean extracts are heated to form thin films by use of electric ovens, the bean curd skin can be produced easily without requiring large, expensive facilities and work-sections. Consequently, a neat bean curd skin can be produced in an easy manner with shorter operating periods industrially and also domestically.

In addition, in the conventional methods to clip by a stick (line) or hand (point), a certain size of space is necessary above the liquid surface of bean extracts at taking up the bean curd skin. In contrast, the combination of the process of taking up thin films using a face portion and the process of forming thin films through heating the bean extracts with an electric oven can downsize the space necessary for these processes and produce simply the bean curd skin.

The eighth aspect of the invention is the method for producing bean curd skin according to any one of the first to seventh aspects, wherein all of the steps described above are carried out under a sterile atmosphere.

In accordance with the method for producing bean curd skin according to the eighth aspect, all the steps described above are carried out under a sterile atmosphere, making possible to carry out sterile packaging easily and resulting in a packaged bean curd skin capable of long term preservation.

The ninth aspect of the invention is a method for producing bean curd skin, comprising heating bean extracts by use of an electric oven to form a thin film at the surface, then taking up the thin film, wherein the output of the electric oven is no less than 300 W, and the bean extracts are heated to no lower than about the temperature at which the thin film forms at the surface of the bean extracts and no higher than the temperature at which the bean extracts initially boil.

In accordance with the ninth aspect of the invention, the output of the electric oven is set to no less than 300 W, and the bean extracts are heated to no lower than about the temperature at which a thin film forms at the surface of the bean extracts and no higher than the temperature at which the bean extracts initially boil, which making possible to form bean curd skin sufficiently to be taken up. In cases where the output of the electric oven is less than 300 W, the bean extracts come to gelatinous or pudding-like as a whole, resulting in bean curd skin with unsatisfactory eating feel and undesirable flavor. Moreover, in accordance with this invention, large machines and operating spaces are unnecessary, and neat bean curd skin can be produced easily with shorter operating times.

The temperature referred to as “about the temperature at which a thin film forms at the surface of the bean extracts” depends on species of bean curd skin, constituents, and presence or absence of additives; for example, although it cannot be determined definitely when heated by electric ovens since heating in containers leads to difficult visual inspection, typically the temperature is about 60° C. The “temperature at which the bean extracts initially boil” indicates the temperature at which small bubbles appear at the surface rather than the temperature at which large bubbles generate such that the liquid surface considerably swells. The temperature depends on species of bean curd skin, constituents, presence or absence of additives and the conditions of heating the bean extracts, similarly as described above, and thus it cannot be determined definitely. The temperature may be as high as 100° C., but over shorter periods this causes no problems.

The tenth aspect of the invention is a bean curd skin produced by way of taking up a thin layer formed at a surface of heated bean extracts, and folding inside the peripheral margin of the thin layer to form a monolayer or multilayer bean curd skin.

The bean curd skin according to the tenth aspect of the invention is a margin-folded bean curd skin of which the peripheral margin is folded inside. The margin-folded bean curd skin according to the tenth aspect may be produced by making use of the area difference between the face portion of the taking up device (area to contact with bean curd skin) and the open face of the bean extract-injecting container (area of bean curd skin). When the area of the face portion of the taking up device is smaller than the area of the resulting bean curd skin, there is some bean curd skin that cannot contact and attach to the taking up device. Such bean curd skin around the taking-up portion that cannot attach to the taking up device is folded toward the inside of the face portion of the taking up device (toward the side of bean extracts) upon pulling up, therefore, a bean curd skin with a margin folded inside can be produced easily. Since the folding is also carried out automatically when pulling up the taking up device, it is unnecessary to contact the bean curd skin directly by hand for folding it, which is also preferable in view of hygiene.

In addition, adjustment of the difference in areas between the face portion of the taking up device (area to contact the bean curd skin) and the open face of the bean extract-injecting container (area of the bean curd skin) may allow the use of variation-rich folding styles, for example, three-folded bean curd skin, a five-layer structure of bean curd skin, etc. can be easily produced.

In addition, the bean curd skin of which the peripheral portion is folded inside has a complex structure wherein the bean extracts (liquid) is interposed in the spaces of the overlapped peripheral margins and also the outside is thicker and the inside is thinner, therefore, can provide a different eating feel for a sheet of bean curd skin between the central portion and the peripheral portion, thus can provide a complex eating feel and flavor of entire bean curd skin upon eating.

By making it a multilayer structure, a laminate of bean curd skin can be produced in which the margin-folded bean curd skin is formed into multiple layers. The laminate of the margin-folded bean curd skin can provide various eating feels by adjusting the lamination conditions by virtue of the bean extracts (liquid) interposed in the spaces of the overlapped margins.

The eleventh aspect of the invention is the bean curd skin according to the tenth aspect, wherein an ingredient is disposed between any layers of the multilayer.

The bean curd skin according to the eleventh aspect of the invention is a laminate of ingredient-containing margin-folded bean curd skin, in which an ingredient is interposed at any interlayer space of the laminate of bean curd skin when the margin-folded bean curd skin is made into multiple layers. In accordance with this invention, various eating feels can be provided by way of adjusting the overlapped condition of the peripheral margin, and also the laminate of bean curd skin can be rich in variations through selecting the types of ingredients.

The twelfth aspect of the invention is a taking up device of bean curd skin, used for producing bean curd skin by way of taking up a thin layer formed at a surface of heated bean extracts, wherein the taking up device comprises a face portion to contact as a surface with the thin layer and a support portion to support the face portion.

The taking up device of bean curd skin according to the twelfth aspect of the invention comprises a face portion to contact as a surface with the thin film and a support portion to support the face portion. The taking up device can take up the bean curd skin as a surface rather than points or lines, therefore, neat bean curd skin can be produced easily with shorter operation times without cutting or damaging the bean curd skin when taking up the bean curd skin.

The thirteenth aspect of the invention is the taking up device of bean curd skin according to the twelfth aspect, wherein the taking up device as a box or ship shape of which the bottom face is the surface portion.

The taking up device of bean curd skin according to the thirteenth aspect of the invention has a box or ship shape of which the bottom face is the face portion which makes as a surface contact with the thin film of bean curd skin. The “box shape” refers to a shape having a closed shape with an empty interior; and the “ship shape” is a shape having a bottom portion and a side portion and the upper face is open. The taking up device of box or ship shape tends to float on the surface of bean extracts. Therefore, the taking up device is easy to use such that the bean curd skin can be taken up while the taking up device is floating on the surface of bean extracts.

The fourteenth aspect of the invention is the taking up device of bean curd skin according to the twelfth or thirteenth aspects, wherein the face portion of the taking up device is formed by way of connecting two or more separable parts.

In the taking up device of bean curd skin according to the fourteenth aspect, the face portion to contact the bean curd skin is formed by connecting two or more separable parts. In accordance with this taking up device, the thin film attached to the face portion is first floated or separated from only one of the two or more parts of the taking up device; then it is peeled from the other part(s), whereby the bean curd skin can be easily peeled from the taking up device.

The fifteenth aspect of the invention is a kit for producing bean curd skin, used for producing bean curd skin by way of taking up a thin film formed at a surface of heated bean extracts, comprising a taking up device of bean curd skin that comprises a face portion to as a surface contact the thin film and a support portion to support the face portion, and a bean extract-injecting container that has an open portion to insert the face portion of the taking up device.

The kit for producing bean curd skin according to the fifteenth aspect comprises a taking up device capable of taking up as a surface the thin film of bean curd skin and a bean extract-injecting container with an open upper face. The taking up device comprises a face portion to as a surface contact the thin film and a support portion to support the face portion; the bean extract-injecting container has, for example, an upper face that is open in order to insert the face portion of the taking up device. In accordance with this invention, the thin layer of bean curd skin is formed at the surface of bean extracts by heating the bean extracts injected into the bean extract-injecting container, and the thin layer of bean curd skin can be taken up by inserting the face portion of the taking up device from the open face of the container and making the face portion as a surface contact the thin layer of the bean curd skin. Moreover, in accordance with this invention, the bean curd skin can be produced conveniently without other equipment. In addition, the bean extracts may be preliminarily contained into the bean extract-injecting container of the kit for producing bean curd skin. The open portion need not be limited specifically as long as it is capable of allowing insertion of the taking up device, and for example, may be those having an open upper portion.

The sixteenth aspect of the invention is the kit for producing bean curd skin according to the fifteenth aspect, wherein the taking up device is of a box or ship shape of which the bottom face is the face portion.

The taking up device provided with the kit for producing bean curd skin according to the sixteenth aspect of the invention is of box or ship shape of which the bottom face is the face portion to as a surface contact the thin film of bean curd skin. The taking up device of box or ship shape tends to float on the surface of bean extracts. Therefore, the taking up device is easy to use such that the bean curd skin can be taken up while the taking up device is floating on the surface of bean extracts.

The seventeenth aspect of the invention is the kit for producing bean curd skin according to the fifteenth or sixteenth aspects, wherein the shape of the bean extract-injecting container is designed so that the side wall stands approximately vertically.

The bean extract-injecting container provided in the kit for producing bean curd skin according to the seventeenth aspect has, for example, an approximately rectangular parallelepiped shape such that the bottom face is rectangular or square and the sidewall face stands approximately vertically. The use of an approximately rectangular parallelepiped container, of which the bottom face and the sidewall face are about perpendicular to each other and of which the upper face is open, may allow uniform heating of the bean extracts contained in the bean extract-injecting container, thus the resulting thin film hardly attaches to the container. Therefore, neat bean curd skin can be easily taken up. In addition, since the edges of the thin film of the bean curd skin do not adhere firmly to the container, the washing efficiency increases when the container is washed for recycling.

The eighteenth aspect of the invention is the kit for producing bean curd skin according to any one of fifteenth to seventeenth aspects, wherein the bean extract-injecting container is formed from a material that can be heated by an electric oven.

The bean extract-injecting container provided in the kit for producing bean curd skin according to the eighteenth aspect is formed from a material that can be heated by an electric oven. In accordance with this invention, the thin film of bean curd skin can be formed through heating by use of an electric oven, thus the bean curd skin can be produced conveniently in the home by way of merely getting the bean extracts without other equipment.

The nineteenth aspect of the invention is the kit for producing bean curd skin according to any one of the fifteenth to eighteenth aspects, further comprising a package of bean extracts filled with bean extracts.

The kit for producing bean curd skin according to the nineteenth aspect comprises a taking up device capable of taking up as a surface the thin film of bean curd skin, a bean extract-injecting container with an open upper face, and a package of bean extracts filled with bean extracts. In accordance with this invention, the bean curd skin can be easily produced through merely heating the bean extracts since a series of elements necessary for producing the bean curd skin are prepared.

### EFFECTS OF THE INVENTION

In accordance with the first aspect of the present invention of the method for producing bean curd skin, the thin film is taken up by a face rather than a point or a line, therefore, neat bean curd skin can be produced simply by anyone without cutting or damaging the bean curd skin upon taking up it. In addition, since the taking up step and the overlapping step can be carried out simultaneously, neat multilayer bean curd skin can be produced without the step to detach the taken up bean curd skin from the taking up device; and also bean curd skin laminates can be obtained with excellent hygiene due to shorter periods necessary for the procedures and fewer production steps. In addition, adjustment of the size of the face portion of the taking up device and the size of the face of the bean curd skin can lead to easy production of folded bean curd skin with folding styles rich in variations.

In addition, an independent step of disposing an ingredient is unnecessary, and ingredients may be interposed in a series of steps to produce laminates of bean curd skin, therefore, ingredients may be easily interposed, the efficiency to produce the laminates of ingredient-containing bean curd skin is enhanced, and also selection of various ingredients allows to produce variation-rich laminates of ingredient-containing bean curd skin.

When the thin film of bean curd skin contacts and attaches to the detachable detaching sheet, the bean curd skin can be easily detached from the taking up device by way of removing the detaching sheet, therefore, the bean curd skin formed on the sheet can be easily processed. Moreover, when the detaching sheet is used as a part of the package material, the detaching sheet, to which the bean curd skin attaches, can be directly used as a packaging material, and the package of bean curd skin can be obtained with a simplified packaging step, making it possible to carry out sterile packaging easily and resulting in a packaged bean curd skin capable of long term preservation.

When a peeling guide is provided, the monolayer or multilayer bean curd skin can be easily peeled from the taking up device starting from the peeling guide, by way of peeling only the portion of the thin film attached to the peeling guide, and separated from the taking up device.

In addition, when the face portion to contact the bean curd skin is formed by connecting two or more parts, releasing the connection of the two or more parts can start the peeling of the thin film from the face portion. For example, the connection of two or more parts is released, and the thin film attached to the face portion is first floated (peeled) from only one of two or more parts of the taking up device; then the other part(s) is separated whereby the bean curd skin can be easily peeled from the taking up device. Furthermore, the two or more parts are released from the connection and peeled simultaneously from the thin film, whereby the thin film can be separated from the taking up device.

In accordance with the inventive method for producing bean curd skin, the bean curd skin can be easily produced by way of heating bean extracts by an electric oven. Containers or heaters of bean extract to produce bean curd skin in heavy use are typically large and expensive. Space for these large instruments and operations are also necessary. In contrast, these instruments and places are unnecessary in the present invention, and the bean curd skin can be simply produced industrially and domestically. Consequently, the bean curd skin, which is attracting attention as a healthy food, may become more popular.

In accordance with the second aspect of the present invention of the margin-folded bean curd skin, the folding is automatically carried out when pulling up the taking up device, therefore, it is unnecessary to contact the bean curd skin directly by hand for folding it, which is preferable in view of hygiene. Furthermore, since the bean extracts (liquid) are interposed in the spaces of the overlapped peripheral portions, the eating feel is different between the central portion (one sheet portion) and the peripheral margin (doubled portion) in one sheet of bean curd skin, which can provide a complex flavor.

In addition, the laminate that is formed by making the margin-folded bean curd skin into multiple layers may provide various eating feels by adjusting the lamination conditions by virtue of the bean extracts (liquid) interposed in the spaces of the overlapped peripheral margins. Furthermore, ingredients interposed at any layer of the second or later layer of the laminate of bean curd skin having the margin-folded bean curd skin formed into multilayer may provide a wide variety of eating feels, and a selection of ingredients may provide variation-rich laminates of the bean curd skin.

The third aspect of the present invention of the device for taking up a thin film of bean curd skin comprises a face portion to as a surface contact the thin film of bean curd skin and a support portion to support the face portion, therefore, the bean curd skin can be taken up by a face rather than a point or a line, thus the bean curd skin is not readily cut or damaged when taking it up. Furthermore, the taking up device of a box or ship shape tends to float on the surface of bean extracts, therefore, the taking up device is easy to use such that the bean curd skin can be taken up while the taking up device is floating on the surface of bean extracts.

In accordance with the fourth of the present invention of the kit for producing bean curd skin, the bean curd skin can be produced conveniently without other equipment. The bean extracts can be heated by an electric oven, making it possible to easily produce bean curd skin in the home. The kit for producing bean curd skin, equipped with a bean extracts package, allows to easily produce the bean curd skin through merely heating the bean extract since the series of elements necessary for producing the bean curd skin are provided.

### BRIEF DESCRIPTION OF THE DRAWINGS

FIG. 1 is a view that shows an inventive kit for producing bean curd skin.

FIG. 2 is a view that shows a taking up device with an L-shape support portion.

FIG. 3A is a view that shows a taking up device, in which the side portion itself is a support portion.

FIG. 3B is a view that shows a taking up device formed from two members.

FIG. 4 is a view that shows a shape of a bean extract-injecting container preferable for the present invention.

FIG. 5 is a view that shows an example of a shape of a bean extract-injecting container according to the present invention.

FIG. 6 is a view that shows a set to produce bean curd skin provided with a package of bean extract.

FIG. 7 is a view that represents the face portion of a taking up device that contacts and attaches to a thin film of bean curd skin.

FIG. 8 is a cross-section that shows a contacting-attaching condition at X-X′ in FIG. 7.

FIG. 9 is a view that shows a taking up device to which a detachable detaching sheet is mounted.

FIG. 10 is a view that shows an example of a mounted detaching sheet.

FIG. 11A is a view that shows an example of a mounted peeling guide.

FIG. 11B is a view that explains a step of peeling a thin film by use of a taking up device formed from two members.

FIG. 11C is a view that shows a step of producing a laminate of bean curd skin by use of a taking up device formed from two members.

FIG. 12 is a view representing a condition that a taking up device attaching a thin film of bean curd skin is raised from a surface of bean extracts.

FIG. 13 is a cross-section of the taking up device at Y-Y′ in FIG. 12.

FIG. 14 is a view of a configuration to produce three-folded bean curd skin.

FIG. 15 is a cross-section at Y₁-Y₁′ in FIG. 14 that shows the taking up device attaching a thin film of bean curd skin.

FIG. 16 is a view that shows a configuration to produce a five-layer structure of bean curd skin.

FIG. 17 is a cross-section at Y₂-Y₂′ in FIG. 16 that shows the taking up device with a thin film of bean curd skin attached.

FIG. 18 is a cross-section of a laminate of bean curd skin that attaches to a taking up device.

FIG. 19 is a view that shows a step of producing an ingredient-containing bean curd skin.

FIG. 20 is a cross-section at Y₃-Y₃′ of a taking up device that attaches to an ingredient-containing bean curd skin.

FIG. 21 is a view that shows a step of removing a detaching sheet from a taking up device; (a) shows the step of removing, and (b) shows a condition of the detaching sheet after the removing.

FIG. 22 is a view that shows an example of a detachable detaching sheet that is used directly for a package of bean curd skin.

FIG. 23 is a flow sheet to produce the package of bean curd skin of FIG. 22.

FIG. 24 is a graph that represents a relation between a cumulative yield and a period in Examples.

FIG. 25 is a graph that represents a relation between a period and a temperature of germination raw bean extract.

### PREFERRED MODE FOR CARRYING OUT THE INVENTION

The embodiments of the present invention will be explained with reference to the figures below.

### Kit for Producing Bean Curd Skin

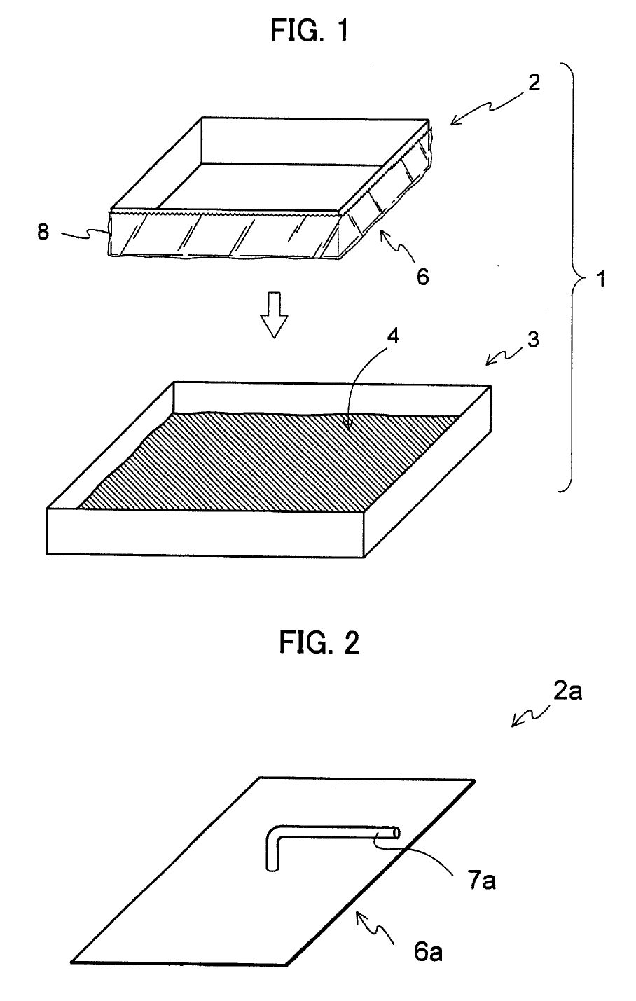

FIG. 1 shows a kit 1 for producing bean curd skin of this embodiment. The kit 1 for producing bean curd skin of this embodiment has a taking up device 2 with a face portion and a bean extract-injecting container 3. The bean extract-injecting container 3 houses bean extracts 4. The taking up device 2 has a face portion 6, and a detaching sheet 8 is mounted to the face portion 6 as required. The use of the kit 1 for producing bean curd skin of this embodiment may make possible to produce conveniently the bean curd skin without other equipments.

### Taking Up Device

In this embodiment shown in FIG. 1, the taking up device 2 has a box shape of which the upper face is open, the bottom face has a face portion 6, and a detaching sheet 8 is mounted to the face portion 6.

The taking up device according to the present invention, which is used to produce bean curd skin by taking up a thin film formed at the surface of heated bean extracts, has a face portion to contact and attach as a surface to the thin film of bean curd skin and a support portion to support the face portion. The face portion of the inventive taking up device have a flat or curved surface as long as it is smoothly capable of contacting and attaching as a surface to the thin film of bean curd skin. A concave portion may be slit or a hole may be pierced at a part of the face portion, provided that the face portion maintains generally a planar shape without degrading the function. The support portion to support the face portion means a portion capable of holding the taking up device by hand, and the shape is not limited specifically as long as it is capable of moving while holding the face portion of the taking up device. The material of the taking up device is also not limited specifically as long as is has a face portion and a support portion, for example, it is desired that the taking up device is formed of plastic in view of light weight and easy handling. The material of the face portion, which is also not limited specifically as long as it is capable of attaching to bean curd skin, is exemplified by polypropylene, polyvinylidene chloride, etc.

It is preferred that the taking up device according to the present invention is of a box or ship shape of which the bottom face is the face portion to as a surface contact the thin film of bean curd skin. Furthermore, the taking up device of box or ship shape tends to float on the surface of bean extracts. Therefore, the taking up device is easy to use such that the bean curd skin can be taken up while the taking up device is floating on the surface of bean extracts.

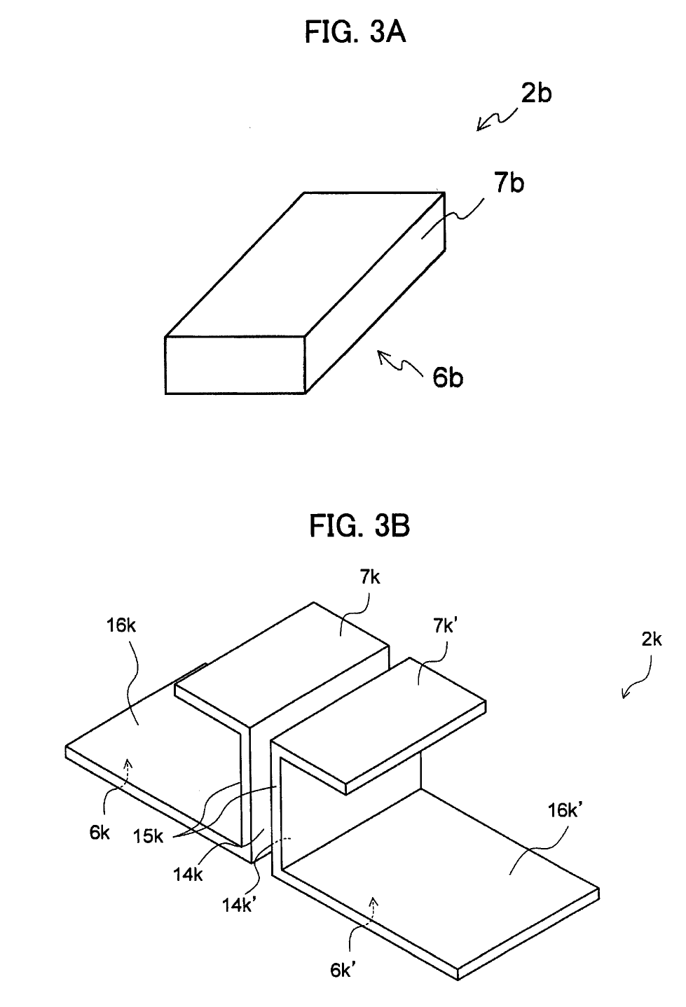

FIGS. 2 to 3B show a variation of the inventive taking up device. FIG. 2 shows a taking up device 2a that has a face portion 6a to as a surface contact the thin film of bean curd skin and an L-shape support portion 7a. FIG. 3 shows a taking up device 2b, face portion 6b, in which the side portion itself is a support portion 7b.

FIG. 3B shows a taking up device 2k, in which members 16k, 16k′ having an approximately squared u-shape are mated at connecting faces 14k, 14k′ to form face portions 6k, 6k′. The members 16k, 16k′ may be connected at the connecting faces 14k, 14k′ in a detachable manner, for example, may be fixed by a clip or a laundry pinch. In a case where the connecting faces 14k, 14k′ are constructed into a hole-and-key shape, they may be connected in a detachable manner. When such a taking up device 2k is used, the thin film of bean curd skin can be easily peeled with no use of a peeling sheet by way of floating (peeling) one member from the thin film of bean curd skin and then peeling the other member as described later.

In addition, a support portion (not shown) may be provided that extends in a horizontal direction from a vertical side 15k besides support portions 7k, 7k′, above the vertical side 15k of the taking up device 2k. When a laminate of bean curd skin is produced, the bean curd skin is taken up, then the taking up device is reversed and allowed to stand for a while. At this stage, the bean extract drops vertically from the undried bean curd skin attached to the face portions 6k, 6k′, thus the support portions 7k, 7k′ will be soiled. In a case that the extending support portion is provided and the bean curd skin is taken up while grasping the support portion by the fingers, continuous use may be assured without soiling the hand.

### Bean Extract-Injecting Container

The upper face of bean extract-injecting Container 3 of this embodiment shown in FIG. 1 is open so that the face portion of the taking up device can be inserted from the open side of the container and the thin layer of bean curd skin can be taken up while making the face portion contact as a surface with the thin film of bean curd skin. The sidewall face has a shape to stand approximately vertically.

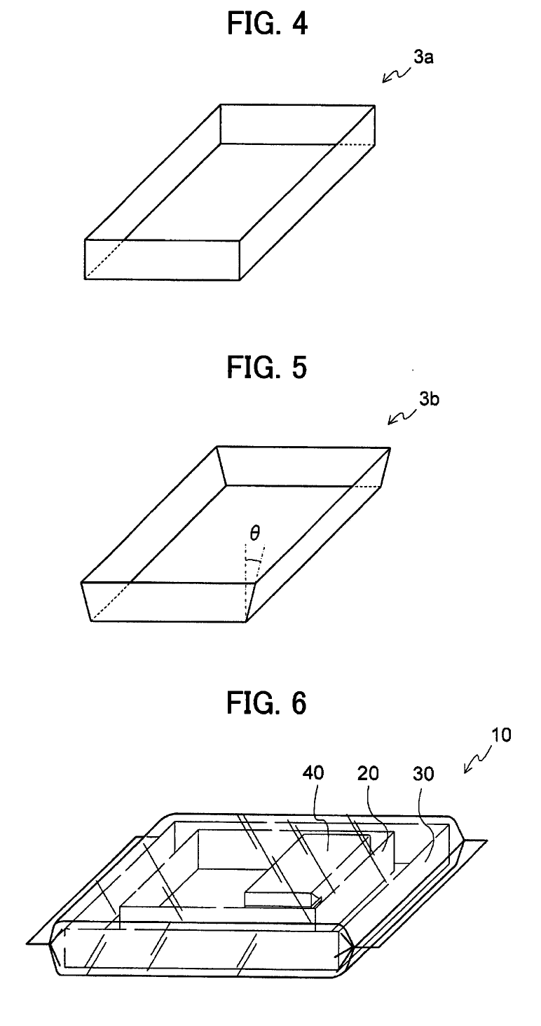

FIG. 4 is a view that shows a shape of a bean extract-injecting container 3a preferable for the present invention. The bean extract-injecting container 3a is approximately a cuboid container, in which the bottom face is rectangular, the bottom face and the side faces are approximately perpendicular, and the upper face is open. In the bean extract-injecting container 3a shown in FIG. 4, the apexes of the bottom face and the intersecting portions of the bottom face and the side faces are formed by straight lines; alternatively, the apexes and the edges may be curved or rounded provided that the bottom face and side faces form an angle of about 90 degrees.

FIG. 5 is a view that shows an example of the shape of a bean extract-injecting container 3b according to the present invention. In the bean extract-injecting container 3b shown in FIG. 5, the sidewall face does not stand perpendicular to the bottom face and the area of the open upper face is larger than that of the bottom face. It is preferred in the inventive bean extract-injecting container that the angle θ of the bottom face and the sidewall face is no more than 45 degrees, more preferably no more than 30 degrees, most preferably, the sidewall face stands perpendicularly with the bottom face (FIG. 4). When such a container is used, the resulting thin film hardly adheres to the container since the bean extracts housed in the bean extract-injecting container are healed uniformly. Therefore, neat bean curd skin can be easily taken up. Furthermore, the washing efficiency to recycle the container is enhanced since the edges of the thin film of heat bean curd skin do not adhere firmly to the container.

It is preferred in the present invention that the material of the bean extract-injecting container is resistant to heating by electric ovens. The electric overt refers to a “cooking apparatus to heat foods by way of irradiating a radio-frequency electromagnetic wave” and generally encompasses overall apparatuses to heat foods by irradiating a microwave of wavelength 2450 MHz. The process to irradiate the microwave may be batch or continuous. Examples thereof include household electric ovens, high output electric ovens in heavy use, and industrial microwave heating apparatuses. Containers of a material resistant to heating by electric ovens allow to heat the bean extracts along with the housing container by electric ovens etc., thus the thin film of bean curd skin can be formed easily also in the home. The material resistant to heating by electric ovens is preferably a plastic such as polypropylene.

The kit 1 for producing bean curd skin may be constructed exclusively from a taking up device 2 having a face portion and a bean extract-injecting container 3, as shown in FIG. 1, or may further contain a bean extracts package filled with bean extracts.

FIG. 6 shows a kit 10 for producing bean curd skin provided with a bean extract package. The inventive kit 10 for producing bean curd skin has a taking up device 20 having a face portion, a bean extract-injecting container 30 and a bean extracts package 40 filled with bean extracts. The kit for producing bean curd skin, equipped with a bean extracts package, allows to easily produce the bean curd skin through merely heating the bean extract since the series of elements necessary for producing the bean curd skin are provided. The use of a container resistant to heating by electric ovens as the bean extract-injecting container allows heating of the bean extracts by electric ovens, which leads to easy production of bean curd skin in the home.

The packaging material of the bean extracts package applied to the present invention is not limited specifically as long as it is capable of containing ordinary drinks; examples thereof include paper packs and PET bottles. The paper pack for drinks is exemplified by upper-roof containers and brick-shape containers (brick packs, brick containers), in particular, the “Tetra Pack (registered trade mark)” by Tetra Pack Co. is popular.

### Bean Extracts

The bean extracts applied to the present invention are not limited specifically and selected from conventional ones. The bean extracts are exemplified by bean extract, adjusted bean extract and bean extract drinks, and these are entirely applicable to the present invention. These specifications are defined in JAS.

The bean extract generally refers to a “milky liquid of collapsed-milled soybeans before solidifying into tofu”, and further include “go” and soybean drinks in the present invention; specifically, “go” taken by collapsing soybean may be used after filtering. The solid content of soybean is typically no less than 8% in the bean extract, usually 10% to 15%. The soybean of raw material for the bean extract is not limited specifically, and ordinary soybean, germinating soybean, shed soybean, soybean embryo, etc. are useful.

The adjusted bean extract indicates those having a soybean content of no less than 6% and being arranged to be easily drinkable by incorporating sugar etc. into the bean extract. The bean extract drink indicates those having a soybean content of 2% to 4%, for example, bean extract containing fruit extract.

In the present invention, plant oil or emulsion-containing plant oil may be added to the raw material of bean curd skin in order to adjust the flavor or eating feel. The plant oil is selected from plant oils other than those derived from beans. There is about 3% by mass or more of soybean oil already in the bean extract. Therefore, the plant oil added in the present invention is one other than those derived from the raw material of bean extract.

The plant oil other than those derived from the raw material of bean extract is not limited specifically, and preferably, is one or more selected from oils and fats of oleic acid and linoleic acid as well as oils and fats of lauric acid. The oils and fats of oleic acid and linoleic acid are those containing oleic acid and linoleic acid as a main component of constitutional fatty acid, and nondrying oil containing much oleic acid as well as semidrying oil containing much linoleic acid are useful. It is particularly preferable that the plant oil available in the present invention other than those derived from the raw material of bean extract is cotton oil or olive oil. When cotton oil is added as the plant oil, the undesirable taste of the soybeans decreases, and the richness and sweetness of the soybeans increase, the eating feel becomes smooth and the creamy taste increases.

The plant oil may be added singly or two or more types may be combined; a combination of two or more species may intensify the flavor still further by a synergic effect. Such a combination is exemplified by the simultaneous use of cotton oil and olive oil. In this case, the ratio of the combination is preferably 1:99 to 99:1 by mass of cotton oil and olive oil, more preferably 10:90 to 90:10.

The added amount of the plant oil is not limited specifically, and preferably, it is an “amount effective to control the flavor”. The addition of plant oil may bring about a delicious taste different from the bean curd skin with no plant oil; the “effective amount to control the flavor” refers to the added amount necessary to represent the different delicious taste. More specifically, the added amount is 0.1% by mass to 10% by mass, more preferably 0.5% by mass to 3.0% by mass, still more preferably 1% by mass to 2.5% by mass. Various favorable tastes may be added and the flavor or eating feel may be improved within this range.

### Method for Producing Bean Curd Skin

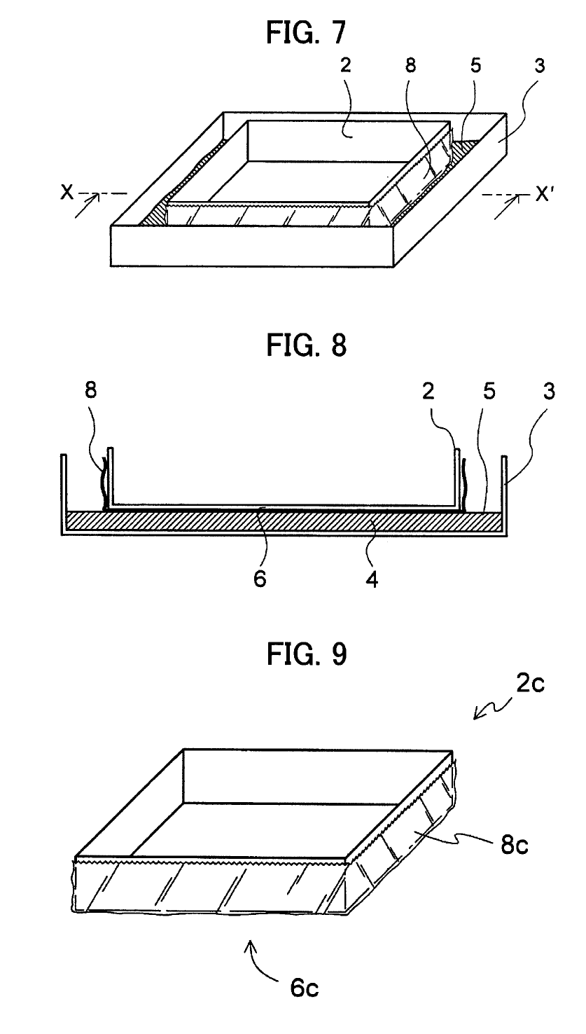

The inventive method for producing bean curd skin will be explained with reference to FIGS. 1, 7 and 12 in the following. The inventive method for producing bean curd skin comprises a step of forming a thin film (FIG. 1), in which bean extracts are heated and a thin film is formed on the surface; a step of attaching the thin film (FIG. 7), in which a face portion of a taking up device is made to as a surface contact the thin film to attach the thin film to the face portion; and a step of taking up the thin film (FIG. 12), in which the taking up device with the thin film is pulled up thereby to take up the thin film.

### Step of Forming Thin Film

In the step of forming a thin film, the bean extracts 4 shown in FIG. 1 are heated and a thin film is formed on the surface. A thin film is formed through evaporating moisture at the surface by heating the bean extracts. The thin film formed at the surface is the bean curd skin. When bean extracts are heated to about 60° C., the concentration of protein increases remarkably at the liquid level due to water evaporation, the high temperature causes an interaction of the protein, yielding a dense gel at the liquid surface while taking in fats and sugars. The product at an earlier stage contains higher contents of proteins and fats; and the product at a later stage contains more sugars. The heating conditions and the heating process in the present invention are not limited specifically as long as they are capable of forming bean curd skin at the surface of bean extracts. For example, a container containing bean curd skin may be heated by putting it into hot water, or heat-treated using an electric oven etc.

### Formation of Thin Film of Bean Curd Skin by Electric Over

A process can also be employed in the present invention whereby bean extracts are heated by an electric oven to produce a thin film and then the thin film is taken up. The electric oven is a “cooking apparatus to heat foods by way of irradiating a radio-frequency electromagnetic wave” and generally refers to overall apparatuses to heat foods by irradiating a microwave of wavelength 2450 MHz. The process to irradiate the microwave may be batch or continuous. Examples thereof include household electric ovens, high output electric ovens in heavy use, and industrial microwave heating apparatuses. When the thin film of bean curd skin is formed by use of an electric oven, the output of the electric oven is set to be no less than 300 W, and the heating is carried out at no lower than about the temperature where the thin film forms at the surface of the bean extracts and no higher than the temperature where the bean extracts boil initially.

The heating is carried out with an output of electric ovens of preferably no less than 300 W, and no more than 1500 W, preferably no more than 1200 W, more preferably no more than 1000 W, still more preferably no more than 700 W. Most preferable is the range of no less than 400 W and no more than 700 W.

It is necessary that the output of electric ovens can heat the bean extracts to 100° C. in a short period. In the case that 100 ml of bean extract (germination raw bean extract, produced in Nisshin OilliO Group Ltd.) was poured into a polypropylene container (170×100×30 mm, 0.5 mm nick, open upper face), for example, and heated by a commercial microwave heating apparatus (produced by SANYO Electric Co., Ltd., microwave heating apparatus Model EM-1500T) equipped with a temperature sensor (by Anritsu Meter Co., fluorescence optical fiber thermometer FX8500), it was heated to about 60° C. at 200 W in 10 minutes or longer, to about 100° C. at 300 W in 5 to 6 minutes, and to about 100° C. at 400 W in 3 to 4 minutes. The bean curd skin produced at 200 W was different from usual bean curd skin, and became gelatinous or pudding-like, which was insufficient in eating feel and inferior in flavor. The bean curd skin produced at 300 W or more was appropriate in film formation and favorable in eating feel and favor, and 400 W or more can produce more favorable bean curd skin.

The heat effect of electric ovens is somewhat different depending on various conditions; when 100 ml of bean extract is heated in an ordinary container (other than containers with a remarkably deep or shallow bottom), an output is required that can heat to 100° C. at least within 10 minutes. When bean curd skin is produced over 10 minutes or longer, the bean curd skin cannot be produced with a favorable eating feel and flavor. Preferably, bean curd skin is produced at an output capable of reaching 100° C. within 5 minutes.

On the other hand, as the output of the electric oven increases, the thin film of bean curd skin is formed in shorter periods, thus the thin film of bean curd skin becomes thinner and more brittle. When heated at no more than 1500 W, bean curd skin can be produced with a favorable eating feel and flavor. In addition, the eating feel of bean curd skin tends to soften as the output increases from 300 W to 1500 W. When heated at an output range of 300 W to 1500 W, the bean curd skin is favorable in eating feel and flavor; in view of the eating feel characteristics of the bean curd skin, the output is preferably no more than 1500 W, more preferably no more than 1200 W, still more preferably no more than 1000 W, most preferably 700 W to 400 W.

It is difficult to define definitely in the present invention “about the temperature where the thin film forms at the surface of the bean extracts” since the temperature depends on the species of bean extracts, constituents, and presence or absence of additives, and also visual observation is hard due to heating in a container when heated by electric ovens; typically, the temperature is about 60° C.

When the bean extracts boil, the resulting bean curd skin bears a hardness inappropriate for foods or surges of liquid level due to generation of large bubbles leads to bean curd skin that is not neat. Therefore, when the heating is stopped at around the stage that small bubbles appear at the surface, bean curd skin can be produced with a favorable eating feel and flavor. The “temperature where the bean extracts boil initially” indicates around the stage that small bubbles appear at the surface rather than a condition that large bubbles generate to significantly swell the surface of the liquid. The temperature depends on the species of bean extracts, constituents, presence or absence of additives, and heating conditions of electric ovens as described above, thus is not limited specifically. Temperature possibly as high as 100° C. may be allowable over a short period.

In the first heating, usually, the bean extracts at 5° C. to 20° C. is heated to 60° C. or higher. Therefore, the first heating requires the longest period. As such, it is effective to shorten the first heating period in order to produce bean curd skin in a short period. For example, the case of bean curd skin produced at 500 W includes the case that some heating is initially carried out at about 1500 W then heating is carried out in an output of about 500 W at around the stage of film formation. For example, a case is included wherein heating is carried out at 1500 W till before boiling and then heating is carried out till initial boiling changing the output to 500 W. A case is also included wherein heating is carried out at 1500 W till lower than “about the temperature where the thin film forms at the surface of the bean extracts” and then heating is carried out at 500 W from “about the temperature where the thin film forms at the surface of the bean extracts” to the “temperature where the bean extracts boil initially”.

The bean curd skin produced at 500 W in the present invention refers to the bean curd skin of which 30% or more of the composition is heated at 500 W to “no lower than about the temperature where the thin film forms at the surface of the bean extracts and no higher than the temperature where the bean extracts boil initially”. For example, the first bean curd skin is formed at 1500 W and the first film is taken. Thereafter, bean curd skin is formed at 500 W and films are taken till the eighth. In this case, the heating at “no lower than about the temperature where the thin film forms at the surface of the bean extracts and no higher than the temperature where the bean extracts boil initially” is carried out at 500 W as regards second to eighth films, therefore, 87.5% of the bean curd skin is produced at 500 W, thus the bean curd skin can be said as one produced at 500 W of heating.

In the present invention, heating at the “temperature where the bean extracts boil initially” is not necessarily essential; for example, a method for producing bean curd skin that comprises at least heating to “temperature where the bean extracts boil initially” and the resulting bean curd skin can be provided. Consequently, bean curd skin can be produced with a favorable eating feel and flavor.

The relation of heating output and heating period to the liquid amount of bean extracts depends on various conditions such as heating conditions, temperatures of the liquid, and the reduction rate of the liquid temperature due to a heating-stop period, thus cannot be defined. The formation of a thin film can be visually judged, but it is often difficult to judge. Therefore, it is possible to produce bean curd skin with a favorable eating feel and flavor by way of deciding the liquid amount, container, output, and liquid components, and measuring in advance, and then heating for a pre-determined period with good repeatability. In addition, since visual judgment is often difficult, it is effective to stop the heating immediately after bubbles generate at the surface of bean extracts. Consequently, bean curd skin can be taken with favorable eating feel and flavor without causing nonuniformity and degrading its appearance.

The descriptions above are applicable to the cases in general where household electric ovens or commercial electric ovens of about 1500 W are used; in cases of industrial electric ovens of larger scale, the descriptions are applicable by scaling up proportionally. In cases of household electric ovens or commercial electric ovens of about 1500 W, generally, 50 to 400 mL of bean extracts is placed into an electric oven of capacity 20 L and heated at 300 W or higher (preferably, 300 to 1500 W). Therefore, when the capacity of the electric oven is enlarged or the amount of bean extracts is increased, the output of the electric oven can be increased proportionally. Various capacities or liquid amounts of bean extracts can be applied to actual industrial electric ovens. When the output of electric ovens is increased, the output and number of magnetrons are not limited specifically.

### Step of Attaching Thin Film

In the step of attaching a thin film, a face portion of a taking up device is made to as a surface contact the thin film to attach the thin film to the face portion (see FIG. 7). That is, the face portion 6 of the taking up device 2 shown in FIG. 1 is made to contact and attach to the thin film of bean curd skin formed in the bean extract-injecting container 3 thereby to reach the condition of FIG. 7. FIG. 7 shows a condition in which the face portion 6 of the taking up device 2 is made to as a surface contact the thin film 5 of bean curd skin formed at the surface of bean extracts 4 contained in the bean extract-injecting container 3 and the thin film 5 of bean curd skin attaches to the face portion 6 of the taking up device 2. FIG. 8 is a cross-section at X-X′ in the contacting-attaching condition of FIG. 7.

### Detaching Sheet

In the present invention, a detachable detaching sheet is mounted on the face portion of the taking up device; preferably, the thin film of bean curd skin is made attach to the detaching sheet in the step of attaching a thin film described above.

FIG. 9 shows an example where a detachable detaching sheet 8c is mounted to a face portion 6c of a taking up device 2c. FIGS. 7 and 8 in the step of attaching a thin film described above show an example where a detaching sheet 8 is mounted to a face portion 6 of a taking up device.

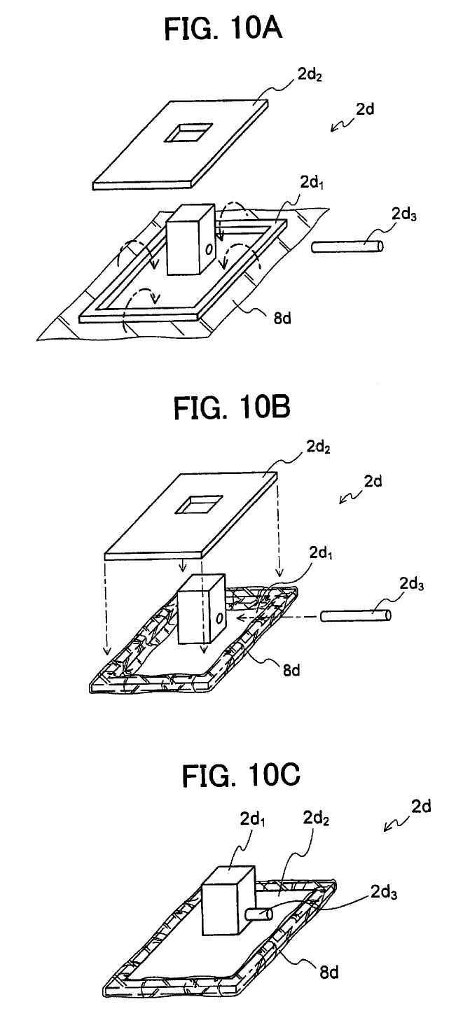

FIG. 10 is a view that shows an example of mounting a detaching sheet. The detaching sheet can be mounted by use of a taking up device 2d shown in FIG. 10. The taking up device 2d shown in FIG. 10 is formed from a part 2d₁ having a face portion, a part 2d₂ to press a detaching sheet 8d, and a rod-like part 2d₃ to connect 2d₁ and 2d₂. When the detaching sheet 8d is mounted, initially, as shown in FIG. 10A, the detaching sheet 8d to be mounted is made to contact the face portion of part 2d₁ of a taking up device. Then, as shown in FIG. 10B, the detaching sheet 8d is wound inside the part 2d₁ of the taking up device. Finally, as shown in FIG. 10C, the detaching sheet 8d wound inside is pressed by the part 2d₂ to press the detaching sheet 8d, and the rod-like part 2d₃ is inserted to connect 2d₁ and 2d₂.

In the present invention, when the thin film of bean curd skin is attached to the detachable detaching sheet, the bean curd skin can be easily taken out from the taking up device by way of removing the detaching sheet. Therefore, the bean curd skin formed as a sheet can be easily processed after removing the sheet. In addition, the usage of the detaching sheet can prevent the taking up device from fouling; and the step of packaging the bean curd skin by use of the detaching sheet as a part of the package material leads to a direct use of the detaching sheet, to which the bean curd skin attaches, as a packaging material, which making it possible to produce a packaged bean curd skin with a simple packaging step.

The material, thickness, etc. of the detachable detaching sheet is not limited specifically, for example, commercially available food wrap film can be used. Sheets with satisfactory requirements can be properly selected and used depending on the use conditions after removal.

### Peeling Guide

In the present invention, a peeling guide to peel the bean curd skin from the taking up device is preliminarily mounted on at least a part of the vicinity of the periphery of the face portion of the taking up device; preferably, the thin layer of bean curd skin is attached to the face portion containing the peeling guide in the step of attaching a thin film described above.

### Step of Peeling Thin Layer

It is preferred in the present invention that the method of producing bean curd skin comprises a peeling step by use of the peeling guide. In the peeling step, the thin film is peeled from the face portion of the taking up device by way of separating the peeling guide from the taking up device after the step of attaching the thin film to attach the thin film to the face portion of the taking up device with the peeling guide. In the peeling step, the monolayer or multilayer bean curd skin can be easily peeled from the taking up device starting from the peeling guide.

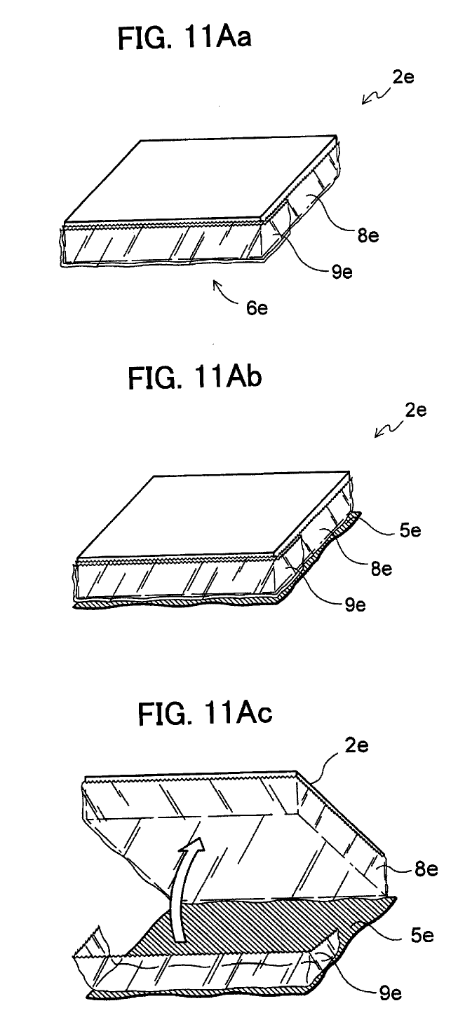

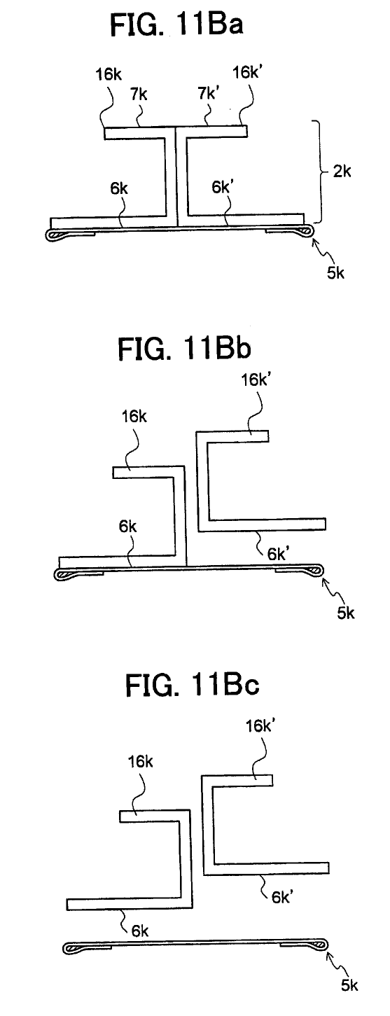

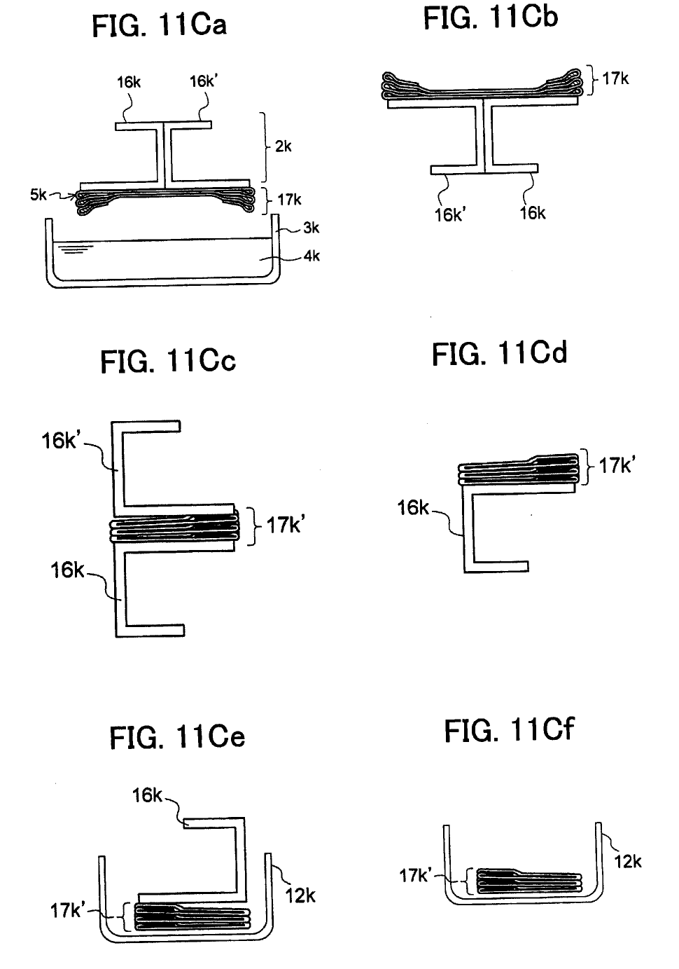

FIG. 11A shows an example where a detaching sheet Ee is mounted to a face portion 6e of a taking up device 2e and also a peeling guide 9e is mounted around the periphery of the face portion 6e having the detaching sheet 8e (FIG. 11Aa). As shown in FIG. 11Ab, a thin layer 5e of bean curd skin is attached to the detaching sheet 8e containing the peeling guide 9e in the step of attaching a thin film. Thereafter, as shown in FIG. 11Ac, the thin layer 5e of bean curd skin is peeled from the detaching sheet 8e mounted to the face portion 6e of the taking up device 2e by way of separating the peeling guide 9e toward the arrow mark from the taking up device 2e to which the detaching sheet is mounted (peeling step).

The material, thickness, etc. of the peeling guide is not limited specifically; examples thereof include commercially available food wrap films, films of plastics etc., thin plates, and bamboo leaf.

FIG. 11B shows a step of peeling the thin film by use of the taking up device 2k shown in FIG. 3B. As shown in FIG. 11Ba, a thin film 5k of bean curd skin is attached to both sides of face portions 6k, 6k′ of the taking up device 2k in the step of attaching the thin film. Thereafter, one member 16k′ of two members 16k, 16k′ of the taking up device 2k is first floated (peeled), as shown in FIG. 11Bb, thereby the thin film 5k of bean curd skin is peeled from one member 16k′. The other member 16k of the taking up device 2k is then peeled as shown in FIG. 11Bc, thereby the thin film 5k of bean curd skin can be completely peeled from the taking up device 2k. In addition, when a laminate is produced, the thin film 5k of bean curd skin is taken up, then the taken up thin film 5k of bean curd skin is sustained temporarily, for example, while disposing the support portion 7k, 7k′ downward so that the thin film 5k of bean curd skin faces upward. Furthermore, the secondary resulting thin film 5k of bean curd skin is similarly taken up by the face portions 6k, 6k′ to form a laminate of bean curd skin. After producing an intended laminate by way of repeating plural times, the laminate can be peeled from the taking up device 2k by a process similar to the step of peeling a thin layer described above.

FIG. 11C shows a step to produce a laminate of bean curd skin 17k′ by use of the taking up device 2k. Initially, a thin film 5k of bean curd skin, formed in a bean extract-injecting container 3k, is attached by use of the taking up device 2k, this step is repeated plural times thereby to produce a laminate 17k of bean curd skin (FIG. 11Ca). Then the taking up device 2k is inverted to make the laminate 17k of bean curd skin upward (FIG. 11Cb). Then one member 16k′ is superimposed on another member 16k such that the face portions of two members 16k, 16k′ are overlapped and the bean curd skin is superimposed by a double-overlapping step to form a laminate 17k′ of bean curd skin having a double thickness of bean curd skin (FIG. 11Cc). One member 16k′ is removed from this condition (FIG. 11Cd), then the laminate is inverted and made to contact a container (bottom material) (FIG. 11Ce). Finally, the laminate 17k′ of bean curd skin is completely peeled from another member 16k (FIG. 11Cf).

This laminate 17k′ of bean curd skin allows to produce thicker laminates of bean curd skin since the laminate of bean curd skin is double-overlapped, thus a favorable eating feel can be attained due to firmness. Furthermore, since bean extract is contained appropriately between the folded-overlapped sides, a delicious bean curd skin can be produced. Furthermore, since the high weight gained by overlapping allows easy separation, the production can be carried out without soiling the hands or work-sections. Furthermore, the double-overlapping allows downsizing the containers for containing the bean curd skin and allows ready production in a small space.

### Step of Taking Up Thin Film

In the step of taking up a thin film, a taking up device, to the face portion of which a thin film attaches, is pulled up, whereby the thin film is taken up. That is, in the step of taking up a thin film, as shown in FIG. 12, a thin film 5 of bean curd skin, attaching to the face portion of the taking up device 2, formed at the surface of bean extracts 4 contained in a bean extract-injecting container 3, is taken up by pulling up the taking up device 2. FIG. 12 shows an example where a taking up device 2 to which a detaching sheet 8 is mounted is used for the face portion. In the step of taking up a thin film, the resulting thin film of bean curd skin can be taken up by a face rather than a point or a line in the present invention, thus the bean curd skin can be protected from cutting or damage when taking it up.

### Margin-Folded Bean Curd Skin

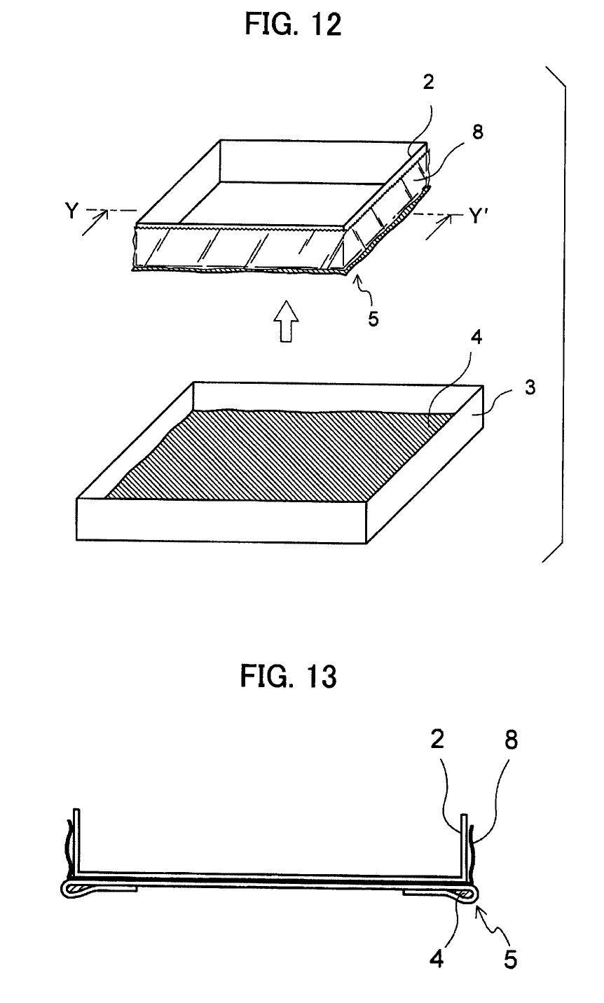

FIG. 13 is a cross-section at Y-Y′ of a taking up device 2 to which the thin film 5 of bean curd skin attaches as shown in FIG. 12 as described above. In FIG. 13, the peripheral margin of attaching thin film 5 of bean curd skin is folded inside of the face portion of the taking up device 2.

In the present invention, when the area of the face portion of the taking up device is smaller than the area of the resulting film of bean curd skin, there is a part of the thin film of bean curd skin that cannot contact and attach to the taking up device. Such a thin film of bean curd skin at the periphery of the taking up portion that cannot attach to the taking up device is folded inside the face portion of the taking up device (toward the bean extracts) upon taking up, thus the margin-folded bean curd skin can be easily taken. The margin-folded bean curd skin has a complex structure wherein the bean extracts (liquid) is sandwiched in the spaces of the doubled peripheral margins and the outside is thicker than the inside, therefore, one sheet of bean curd skin has a differences in eating feel between the center and peripheral margin, thus a complex eating feel and flavor are provided for the entire bean curd skin upon eating. Furthermore, the folding is automatically carried out when the taking up device is pulled up, neat bean curd skin can be easily produced with a shorter operating period, and it is preferable from a hygiene standpoint since the bean curd skin does not have to be touched directly by hand.

The margin-folded bean curd skin shown in FIG. 13 shows a condition wherein bean extracts 4 are sandwiched in the spaces of the doubled peripheral margins. Furthermore, folding of the peripheral margin is automatically carried out when the taking up device is pulled up, therefore, it is preferable from a hygiene standpoint since the bean curd skin does not have to be touched directly by hand for the folding.

In the present invention, folding processes rich in variations can be employed by way of adjusting the differences in areas between the face portion of the taking up device (face to contact the bean curd skin) and the open face of the bean extract-injecting container. For example, three-folded bean curd skin, bean curd skin with a five-layer structure, etc. can be produced. The variations of margin-folded bean curd skin will be explained with reference to figures in the following.

### Three-Folded Bean Curd Skin

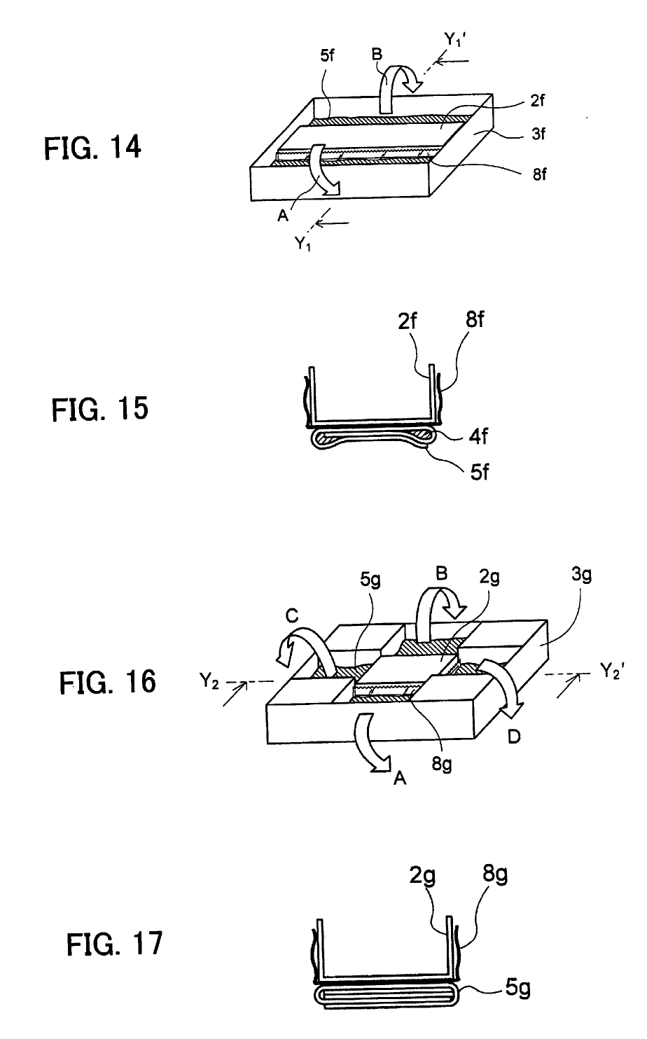

As shown in FIG. 14, in order to produce three-folded bean curd skin, a taking up device 2f is used of which the width is about one third of the length of any directional axis of the open face (film face of bean curd skin) of the bean extract-injecting container. FIG. 14 is a view in which such a taking up device 2f is contacted with and attached to a thin film 5f of bean curd skin formed inside a bean extract-injecting container 3f and the taking up device 2f is disposed at approximately the center of the thin film. The thin film of bean curd skin is folded toward the arrow A and B directions in order when pulling up the taking up device 2f. FIG. 15 is a cross-section at Y₁-Y₁′ of the taking up device 2f to which the three-folded thin film of bean curd skin of FIG. 14 attaches. FIGS. 14 and 15 show an example where a wrap film is mounted to the face portion of the taking up device 2f as a detaching sheet 8f.

### Bean Curd Skin of Five-Layer Structure

As shown in FIG. 16, in order to take a thin film of bean curd skin in a five-layer structure, the taking up device 2g is contacted with and attached to approximately the central site of the film 5g of bean curd skin by use of a bean extract-injecting container 3g with a cross-shaped open portion. Then the thin film of bean curd skin is folded in the A, B, C and D directions shown by arrows when pulling up the taking up device 2g. FIG. 17 is a cross-section at Y₂-Y₂′ in FIG. 16 showing a condition wherein the thin layer of bean curd skin is folded and overlapped into five layers and attaches to the taking up device 2g. In the example shown in FIGS. 16, 17, a wrap film is mounted to the face portion of the taking up device 2g as the detaching sheet 8g.

### Drying of Bean Curd Skin

In the present invention, when the face portion of the taking up device is disposed upwards and the attaching bean curd skin is immediately peeled from the face portion, the bean curd skin containing a large amount of bean extract (liquid) can be produced since the bean extracts remain between the thin film of bean curd skin and the taken-up and upwards disposed face. The bean curd skin containing a large amount of bean extract (liquid) can afford an eating feel like drawn bean curd skin. On the other hand, when the bean curd skin is allowed to stand for a while rather than peeling from the face of the taking up device, bean curd skin containing a small amount of bean extract (liquid) can be obtained after drying the film of bean extract (liquid). Bean curd skin containing a large amount of bean extract (liquid) can afford an eating feel like sashimi bean curd skin. The present invention can provide bean curd skin with various eating feels depending on the level of drying the bean curd skin and thus can respond to a wide variety of tastes.

In addition, the bean curd skin can be produced with various hardnesses and eating feels by way of adjusting the heating temperature of the bean extracts, times of taking up the film of bean curd skin after heating, and heating times. For example, when a bean extract is heated to 80° C. or higher and allowed to stand till cooling to about 60° C., the film of bean curd skin formed during the period can be thicker than a bean curd skin taken up immediately after heating. In addition, when reheating and repeating the steps described above afterward, a bean curd skin can be produced with a greater thickness compared to the bean curd skin produced through one heating. As such, the hardness and eating feel can be adjusted.

### Laminate of Bean Curd Skin

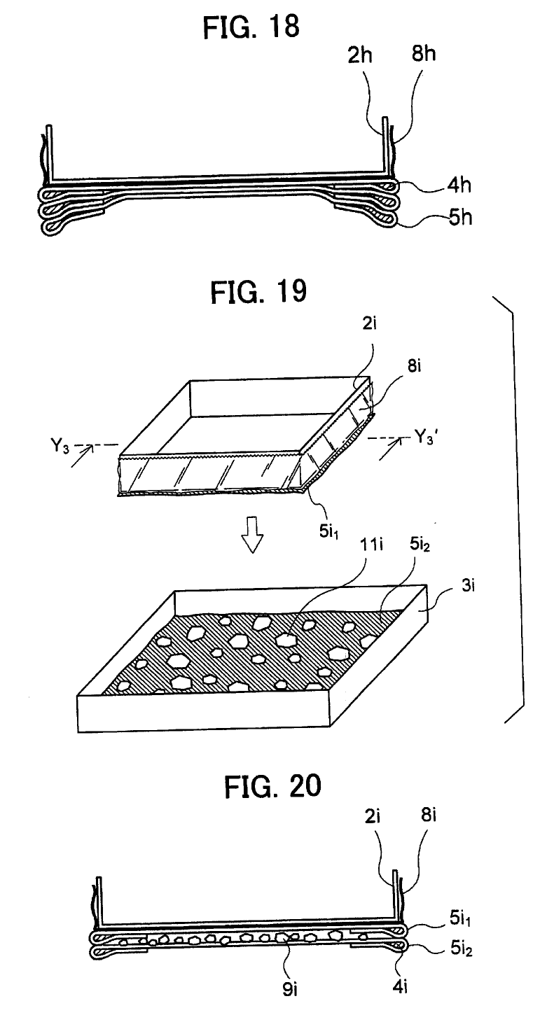

FIG. 18 is a cross-section of a laminate 5h of bean curd skin attaching to the taking up device 2h. In the present invention, plural sheets of bean curd skin can be laminated without providing a step to remove the taken up bean curd skin from the taking up device, that is, while maintaining the condition that the taken up bean curd skin attaches to the face portion of the taking up device 2h. In accordance with the inventive production method, since the taking up step and the laminating step can be carried out at the same time, the laminating step is unnecessary after removing the pulled up bean curd skin from the taking up device. Therefore, a neat bean curd skin can be easily produced and also the operating time can be shortened.

In the present invention, not only the taking up step and the laminating step can be carried out at the same time, but also the peripheral margin of the taken up film of bean curd skin can be automatically folded when pulling up the taking up device. Consequently, not only the production efficiency of the laminate of bean curd skin is enhanced, but also it is preferable from a hygiene standpoint since the bean curd skin does not have to be touched directly by hand.

### Laminate of Ingredient-Containing Bean Curd Skin

FIG. 19 is a view that shows a step of producing an ingredient-containing bean curd skin. In the case of a laminate of ingredient-containing bean curd skin, the thin film 5i₁ of bean curd skin, formed inside the bean extract-injecting container 3i, is initially contacted with and attached to the face portion of the taking up device 2i and is taken up. Then the bean extract, contained in the bean extract-injecting container 3i, is heated to form a thin film 5i₂ of bean curd skin on the surface, and sandwiching ingredients 11i are disposed on the resulting thin film 5i₂ of bean curd skin. Then the thin film 5i₂ of bean curd skin, on which the ingredients 11i are disposed, can be produced through taking up by use of the taking up device 2i to which the thin film 5i₁ is already attached. FIG. 20 is a cross-section at Y₃-Y₃′ of the taking up device, to which the laminate of ingredient-containing bean curd skin attaches. FIGS. 19 and 20 show an example in which a detaching sheet 8i is mounted to the face portion of the taking up device 2i.

In the present invention, the ingredient can be selected from those matching with the flavor of bean curd skin, such as foods like processed fish paste, fried egg, tofu, yam and sausage, and condiments like Chinese pepper, pepper, citron shichimi and perilla.

When the laminate of ingredient-containing bean curd skin is produced, a film of bean curd skin is preferably used that has sufficient strength that it will resist cutting or breaking upon sandwiching the ingredients. Therefore, it is preferred that the bean curd skin itself is formed thick; for example, the film of bean curd skin is formed continuously as plural layers at the liquid level without taking up, thereby the film of bean curd skin can be obtained with sufficient strength and durability to sandwich the ingredients.

Such a bean curd skin may be obtained by the process described below, for example. Initially, heating for 3 minutes by an electric oven at 500 W to form a film of bean curd skin, followed by allowing to stand for 30 minutes, then thickening the film of bean curd skin by way of reheating for one minute while the film of bean curd skin being formed and taking up (first film). Then heating furthermore the bean extract in the container for 50 seconds by the electric oven, followed by allowing to stand 30 seconds to form a film of bean curd skin, disposing an ingredient on the film of bean curd skin, and heating again for 50 seconds. The film (second film) of bean curd skin, on which the ingredient being disposed, is taken up by use of the taking up device of which the face portion attaching the initial bean curd skin, thereby a laminate of ingredient-containing bean curd skin may be obtained, in which the ingredient is sandwiched between two films of bean curd skin.

In the present invention, the peripheral margin of the film of bean curd skin can be folded without detaching the taken up bean curd skin from the taking up device, therefore, the laminate of ingredient-containing bean curd skin of which the peripheral margin being folded can be efficiently produced. Consequently, not only the production efficiency of the laminate of bean curd skin is enhanced, but also it is preferable from a hygiene standpoint since the bean curd skin does not have to be touched directly by hand. Various eating feels can be also provided by adjusting the overlapping condition of the peripheral margin.

There may be one layer or plural layers in the laminate of bean curd skin on which the ingredient of the laminate of ingredient-containing bean curd skin is disposed. In the present invention, selection of the types of ingredients allows to produce variation-rich laminates of ingredient-containing bean curd skin; daily dishes of processed bean curd skin can be produced that will suit someone's taste by way of seasoning the resulting laminate of ingredient-containing bean curd skin afterward with condiments such as soup stock and soy sauce.

### Package of Bean Curd Skin

In the present invention, the package of bean curd skin can be effectively produced by way of removing the detachable detaching sheet mounted to the face portion of the taking up device described above from the taking up device and then directly making use of it as a part of the package material. Since the detaching sheet that bears bean curd skin can be directly utilized as a package material, packages of bean curd skin can be produced with a simple packaging step.

For example, when a heat-sealable sheet is employed as the detachable detaching sheet, after removing the sheet to which the bean curd skin is attached, a package containing bean curd skin can be easily obtained by way of heat-sealing this sheet and the container (bottom material) capable of containing bean curd skin. When these procedures are carried out in a sterilized environment such as sterile rooms at this stage, sterile-packed packages can be obtained. Furthermore, when a deoxidizing film containing a deoxidizer is employed as the detachable detaching sheet or a deoxidizer is encapsulated in the package, degradation due to oxidization can be prevented, thus the flavor immediately after the production can be maintained for a long period.

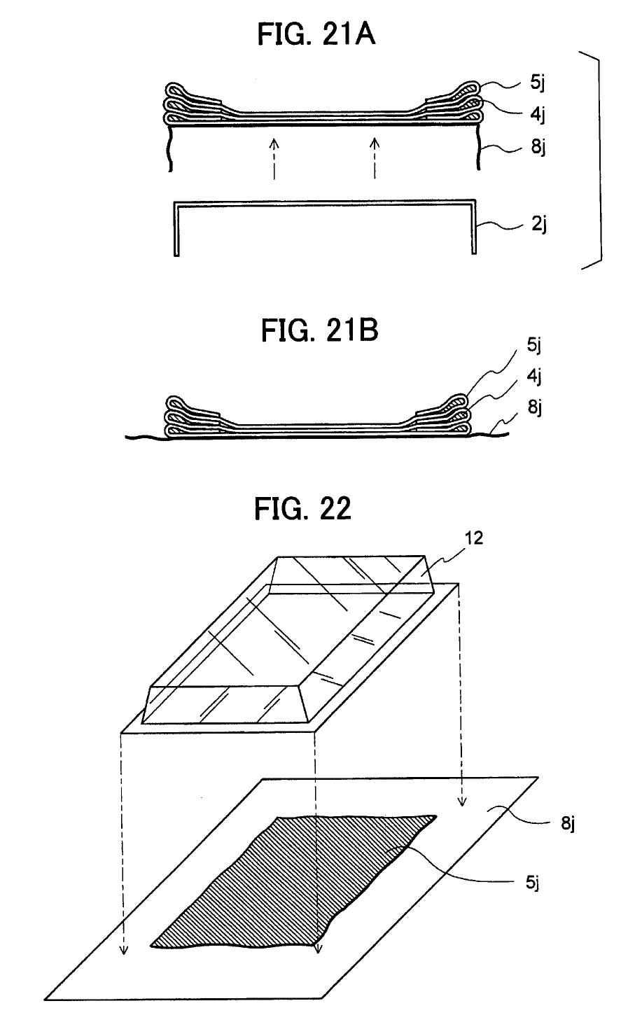

FIGS. 21 to 23 show an example where a detachable detaching sheet is directly utilized as a part of a package of bean curd skin. FIG. 21 is a view that shows a step of removing a detaching sheet from a taking up device. FIG. 21A shows a condition of removing the detaching sheet 8j from the taking up device 2j after attaching the laminate of the thin film 5j of bean curd skin to the detaching sheet 8j that is mounted to the taking up device 2j. FIG. 21B is a view of the detaching sheet 8j that is spread into a planar shape after the detaching. The laminate of the thin film 5j of bean curd skin attaches on the detaching sheet 8j.

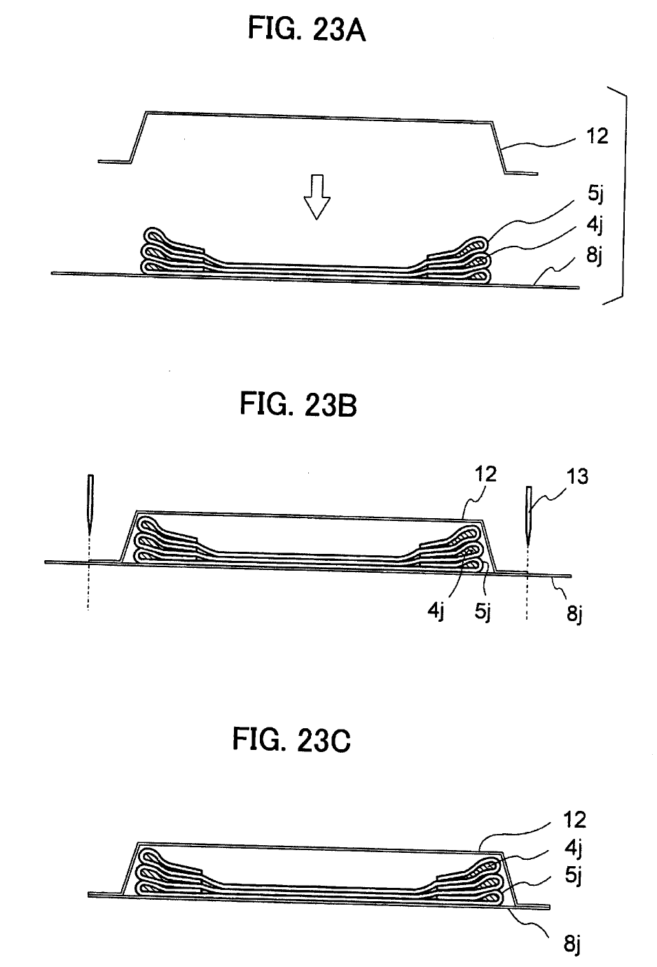

FIG. 22 is a view that shows a condition to make use of the removed detaching sheet directly for a package of bean curd skin. A container (bottom material) 12 capable of containing the laminate of the thin film 5j of bean curd skin is disposed on the detaching sheet 8j to which the laminate of the thin film 5j of bean curd skin attaches. FIG. 23 shows a step of packaging a laminate of bean curd skin. FIG. 23A is a cross-section that transversely shows the condition of FIG. 22. A container (bottom material) 12 capable of containing the laminate of the thin film 5j of bean curd skin is disposed on the detaching sheet 8j to which the laminate of the thin film 5j of bean curd skin attaches. Then the container (bottom material) 12 and the detaching sheet 8 are heat-sealed in a condition wherein the laminate of the thin film 5j of bean curd skin is housed, consequently, the laminate of the thin film 5j of bean curd skin is tight-sealed and packaged. After the heat seal, the excessive detaching sheet 8j is cut off by the cutter as shown in FIG. 23B, the package of a laminate of bean curd skin shown in FIG. 23C can be obtained.

### EXAMPLES

The present invention will be explained more specifically with reference to Examples in the following, to which the present invention should is in no way limited.

### Taking Up by Face Portion

Using the kit for producing bean curd skin as shown in FIG. 6, bean curd skin was produced in the order of FIGS. 1, 7 and 12 according to the procedures below.

### Example 1

200 ml of germination bean extract was poured into a polypropylene container (200 mm×130 mm, surface area: 0.026 m²), and heated till a thin film of bean curd skin was formed by use of a 500 W electric oven (produced by SANYO Electric Co., Ltd.). Then using a taking up device, having a plain face of 170 mm×100 mm and of which the face portion was covered with a wrap, the resulting thin film of bean curd skin was attached as a surface to the face portion, the taking up device was vibrated right-left and back-forth at the attaching height, thereby the thin film of bean curd skin was taken up by the face after separating the portion where the bean curd skin contacted and adhered firmly to the inner wall of the container. The heating was continued further after the taking up, and the newly generated bean curd skin was taken up, similarly to the first film, by the taking up device attaching the bean curd skin. After attaching a total of eight films to the taking up device, the laminate of bean curd skin was peeled off from the taking up device starting from the peeling wrap. The period to form the thin film of bean curd skin and the cumulative yield were measured for each layer after peeling. The results are shown in Table 1. The required period to accumulate eight layers on the wrap was 800 seconds.

### Example 2

A laminate of eight layers was produced by taking up thin films of bean curd skin in the same manner as Example 1, except that the germination bean extract was changed into 204 g of germination bean extract with 2.5 g of emulsified cotton oil (cotton oil:germination bean extract=4:6) (content of the oil added in the bean extract: 0.5%) added. The period to form the thin film of bean curd skin and the cumulative yield were measured for each layer after peeling. The results are shown in Table 1. The required period to accumulate eight layers on the wrap was 804 seconds.

TABLE 1

| | Example 1 | | Example 2 | |
|---|---|---|---|---|
| | period | cumulative | period | cumulative |
| | (sec) | yield (g) | (sec) | yield (g) |
| 1st film | 210 | 6.3 | 210 | 11.25 |
| 2nd film | 70 | 19.2 | 70 | 17.25 |
| 3rd film | 70 | 25.2 | 70 | 23.05 |
| 4th film | 60 | 31.3 | 60 | 29.05 |
| 5th film | 60 | 38.2 | 60 | 35.35 |
| 6th film | 60 | 44.2 | 60 | 42.05 |
| 7th film | 60 | 50.3 | 60 | 49.55 |
| 8th film | 50 | 56.9 | 50 | 57.05 |
| total necessary | 800 | | 804 | |
| period (sec) | | | | |

As a result of a flavor test, the bean curd skin produced from the germination bean extract with cotton oil added (Example 2) was milder in eating feel than that produced from the bean extract with no cotton oil (Example 1).

### Taking Up by Line

### Comparative Example 1

200 ml of bean extract was poured into a polypropylene container the same as that of Example 1, and a thin film of bean curd skin was formed through heating by use of a 500 W electric oven. After separating the portion where the bean curd skin contacted with and adhered firmly to the inner wall of the container by use a stainless round bar of 1 mm diameter bend-worked into an L-shape, the bean curd skin was taken up by the stainless round bar. The taken up film of bean curd skin was transferred on a wrap, the films of bean curd skin taken up afterward similarly were superimposed thereon to obtain a laminate of bean curd skin. The period to form the thin film of bean curd skin and the cumulative yield were measured for each layer after peeling. The results are shown in Table 2.

TABLE 2

Comparative Example 1

| | period | cumulative |
|---|---|---|
| | (sec) | yield (g) |
| 1st film | 210 | 4.0 |
| 2nd film | 70 | 8.7 |
| 3rd film | 70 | 12.5 |
| 4th film | 60 | 17.1 |
| 5th film | 60 | 21.9 |
| 6th film | 60 | 26.5 |
| 7th film | 60 | 30.9 |
| 8th film | 50 | 35.8 |
| total necessary | 912 | |
| period (sec) | | |

Comparative Example 1 had a lower cumulative yield than Example 1. The reason for this is believed to be that the bean extract easily drops when taking up the bean curd skin by use of the round bar.

The period required to take up the film of bean curd skin was measured for Example 1 and Comparative Example 1, consequently, the period was 20 seconds in Example 1 and 34 seconds in Comparative Example 1 on average. The period required for the taking up corresponds to such two motions as, in Example 1, (i) attaching the taking up device with a plane face to the bean curd skin formed at the liquid level of the bean extract bath and (ii) pulling up the taking up device attaching the bean curd skin from the liquid level of the bean extract bath and placing the taking up device while disposing the attaching face upwards.

In contrast, Comparative Example 1 requires four motions: (i) separating the portion where the bean curd skin, formed at the surface of the bean extract bath, adheres to the bean extract bath by using the L-shaped taking up device, (ii) inserting carefully the L-shaped taking up device from the periphery of the bean extract bath below the bean curd skin and taking up the thin film of bean curd skin, (iii) disposing the bean curd skin on a readied wrap while setting the shape, and (iv) pulling out the taking up device.

As described above, the process to take up by a face portion can eliminate two motions required for taking up the bean curd skin, which leads to more prompt taking up operations. Consequently, the period required for the operations can be shortened. Moreover, conventional processes to take up by a stick or a rod such as Comparative Example 1 require an artisan's skill since nonexperts provide thin films of bean curd skin with pores or uneven thickness of bean curd skin, in contrast, it is demonstrated that the present invention can provide uniform and neat bean curd skin by a simple taking up procedure without requiring expert skill.

### Eating Feel of Laminate of Bean Curd Skin

### Example 3

200 ml of germination raw bean extract was placed in a polypropylene container (trade name: Ephpico Hotdeli 4 (produced by Ephpico Co.), surface area: 0.03 m² and heated by a 500 W electric oven nine times for 3 minutes, 1 minute, 50 seconds, 40 seconds, 40 seconds, 40 seconds, 40 seconds, 40 seconds and 30 seconds, the resulting thin films of bean curd skin were taken up every time in order by use of a face of a taking up device (a polypropylene plate of 200×140 mm, with a wrap applied entirely, a part of edge being further wrapped in order to make easy to detach bean curd skin), thereby to obtain a laminate of bean curd skin. While heating by the electric oven each time, the taking up device with a film of bean curd skin attached was disposed in one of the two manners below to support bean curd skin.
A: taking up device is disposed such that the attaching film of bean curd skin faces upward
B: taking up device is propped such that the attaching film of bean curd skin faces transversely

The yield and eating feel of the laminates of bean curd skin produced under the respective positioning manners are shown in Table 3.

TABLE 3

| manner to dispose | total yield | |
|---|---|---|
| taking up device | (g) | eating feel |
| A: | 45.4 | content of bean juice is high |
| surface of bean curd skin | | like “drawn bean curd skin” |
| faces upward | | |
| B: | 38.0 | relatively hard and elastic |
| surface of bean curd skin | | like “sashimi bean curd skin” |
| faces transversely | | |

The amount of bean extract sandwiched between the layers of a laminate of bean curd skin depends on the positioning manner, therefore, there appeared a difference between yields of laminates. The degree of containing bean extracts can alter the eating feel and thus can correspond to the needs for a variety of eating feels.

### Production of Laminate of Ingredient-Containing Bean Curd Skin

### Example 4

200 ml of germination raw bean extract (bean extract solid content: 12%) was placed in a polypropylene container (trade name: Ephpico Hotdeli 4 (produced by Ephpico Co.), surface area: 0.03 m²) and heated by a 500 W electric oven for 3 minutes to form a film of bean curd skin, followed by allowing to stand for 30 seconds. Then heating was carried out again for 1 minute while leaving the resulting film of bean curd skin to thicken the film of bean curd skin (first film). The thickened film of bean curd skin was taken up by a taking up device having a planar face (210 mm×140 mm) of approximately the same area as the surface of the bean extract liquid in the polypropylene container containing the bean extract. The bean extract contained in the container was further heated for 50 seconds by an electric oven, followed by allowing to stand and cool for 30 seconds thereby to form a film of bean curd skin. Three sheets of processed fish paste cut into a thickness of 3 mm (total 10 g) were disposed on the resulting film of bean curd skin, which was then heated again for 50 seconds. The resulting film of bean curd skin (second film), on which the processed fish paste being disposed, was taken up by the taking up device attaching the initial bean curd skin on its face portion, thereby to obtain a laminate of ingredient-containing bean curd skin where the processed fish paste was sandwiched between two films of bean curd skin. This laminate of ingredient-containing bean curd skin was made into a delicious daily dish of processed bean curd skin through heating with a soup stock and seasoning with soy sauce etc.

### Example 5

A laminate of ingredient-containing bean card skin was produced by the same procedures as those of Example 3 except that the germination raw bean extract was changed into germination raw bean extract with 2% cotton oil added. In the case produced from the germination raw bean extract with cotton oil added, the film of bean curd skin was softer, and a daily dish of bean curd skin having softer eating feel was similarly obtained after seasoning with a soup stock etc.

### Sterile-Packed Package of Laminate of Bean Curd Skin

### Example 6

Sterile-packed bean curd skin was prepared by the procedures below in a sterile room. All of the taking up devices, bean extract-injecting containers, and warming devices were sterilized by a high-pressure steam process, and films and trays were sterilized by a gamma-ray sterilizing process.

Setup of Taking Up Device with Face

A rectangular parallelepiped molded body 170 mm long by 100 mm wide by 30 mm high made of polypropylene with an open face was used as a taking up device with a face. The taking up device was covered with a deoxidizer film (trade name: Ageless Aumac, produced by Mitsubishi Gas Chemical Co.) formed of a film resin compounded with a deoxidizer, the deoxidizer film excessive from the open face was pushed into and pressed by a lid (made of polypropylene, 168 mm long by 98 mm wide by 20 mm high) thereby to fix the deoxidizer film to the taking up device. The size of the planar face of the taking up device to take up bean curd skin was 170 mm long by 100 mm wide.

### Production of Laminate of Bean Curd Skin

400 ml of sterilized germination raw bean extract (solid content: 12%) was contained into a stainless container (200 mm long by 130 mm wide by 40 mm high) and the warming in hot water was carried out by a burner. After 10 minutes, the resulting bean curd skin was taken up by a taking up device mounting the deoxidizer film described above. Then the procedure to form a film of bean curd skin by heating the stainless container containing bean curd skin and to take up the resulting thin film of bean curd skin was repeated seven times and the bean curd skin was superimposed on the face of the taking up device every time thereby to obtain a laminate NSYF-005 of bean curd skin.

### Production of Sterile Pack

When the yield of the laminate of bean curd skin came to 40 g or more, the deoxidizer film attaching the laminate of bean curd skin was detached from the taking up device. A polypropylene tray shaped so as to inset the bean curd skin into the tray was overlapped on the resulting deoxidizer film attaching the laminate of bean curd skin, and the margin of the tray and the film were heat-sealed to melt and crimp thereby to obtain sterile-packed bean curd skin. The resulting sterile-packed bean curd skin showed no noticeable degradation in flavor even after 4 months from its preparation, generated no bitter taste due to oxidation, and exhibited no changes from immediately after its production.

### Example 7

Sterile-packed bean curd skin was prepared by the procedures below in a sterile room. All of the taking up devices, bean extract-injecting containers, and warming devices were sterilized by a high-pressure steam process, and laminate films, trays and deoxidizer were sterilized by a gamma-ray sterilizing process.

Setup of Taking Up Device with Face

A taking up device mounted with a laminate film was set up in the same manner as Example 6 except that the laminate film was used instead of the deoxidizer film. The size of the planar face of the taking up device to take up bean curd skin was 170 mm long by 100 mm wide similarly to Example 6.

### Production of Laminate of Bean Curd Skin

A laminate of bean curd skin was obtained by way of carrying out similar procedures to those of Example 6 and superimposing bean curd skin on the face of the taking up device.

### Production of Sterile Pack

When the yield of the laminate of bean curd skin came to 40 g or more, the laminate film attaching the laminate of bean curd skin was detached from the taking up device. A deoxidizer (trade name: FS-20, produced by Mitsubishi Gas Chemical Co.) and a polypropylene tray shaped so as to inset the bean curd skin into the tray were overlapped on the resulting laminate film attaching the laminate of bean curd skin, and the margin of the tray and the film were heat-sealed to melt and crimp thereby to obtain sterile-packed bean curd skin. The resulting sterile-packed bean curd skin showed no noticeable degradation in flavor even after 4 months from its preparation, generated no bitter taste due to oxidation, and exhibited no changes from immediately after its production.

### Margin-Folded Bean Curd Skin

### Example 8

### Production of Kit for Producing Bean Curd Skin

A polypropylene sheet 0.3 mm thick was processed to form a container for bean extracts 30 mm high by 130 mm wide by 200 mm long. The same polypropylene sheet was processed to form a box 30 mm high by 100 mm wide by 170 mm long as a device for taking up bean curd skin. Then the face portion for the face to take up bean curd skin was wound with a wrap to form a device for taking up bean curd skin having a detachable sheet. The area of the face portion of the taking up device was 100 mm×170 mm, which was smaller than that of the open face 130 mm×200 mm of the bean extract-injecting container.

### Taking Up of Bean Curd Skin

200 ml of germination raw bean extract was placed in a bean extract-injecting container and heated by a 500 W electric oven for 3 minutes to form a thin film of bean curd skin. Then the face portion of the taking up device was contacted and attached to approximately the central portion of the thin film of bean curd skin formed in the bean extract-injecting container, and the thin film of bean curd skin was taken up. At this stage, the thin film of bean curd skin, formed at the portion corresponding to the area difference between the face portion of the taking up device and the open face of the bean extract-injecting container, was folded inside the face portion of the taking up device. Consequently, the resulting bean curd skin represented a double structure where only the peripheral margin was folded into two layers. The bean curd skin, of which the peripheral margin having the double structure, exhibited different eating feels between the central portion and the peripheral margin in one sheet of bean curd skin, and thus had a complex flavor.

### Electric Power of Heating Electric Oven

### Example 9

100 ml of germination bean extract was filled into a polypropylene container (trade name: FT710 (produced by Ephpico Co.), 100 mm wide by 150 mm long) and heated by a 1500 W electric oven to form a film of bean curd skin. Then using a polypropylene container (700×100×20 mm) of a taking up device of which the face portion being wrapped, the resulting thin film of bean curd skin was attached to the wrapped face, thereby the thin film of bean curd skin was taken up by the face. These procedures were carried out five times, and the total yield and the period to form a film of bean curd skin were measured up to the fifth film. The results are shown in Table 4. A commercial microwave heating apparatus (produced by SANYO Electric Co., Ltd., microwave heating apparatus Model EM-1500T) was used for the 1500 W electric oven in Examples 9 to 13.

TABLE 4

| | total | total |
|---|---|---|
| | period | yield |
| | (sec) | (g) |
| 1st film | 23 | 1.01 |
| 2nd film | 34 | 2.20 |
| 3rd film | 44 | 3.84 |
| 4th film | 51 | 5.05 |
| 5th film | 61 | 6.60 |

### Example 10

100 ml of germination bean extract was filled into a polypropylene container (trade name: FT710 (produced by Ephpico Co.), 100 mm wide by 150 mm long) and heated by a 1500 W electric oven for 20 seconds and 500 W electric oven for 30 seconds, i.e. for 50 seconds in total, to form a film of bean curd skin. Then using a polypropylene container (70×100×20 mm) of a taking up device of which the face portion was wrapped, the resulting thin film of bean curd skin was attached to the wrapped face, thereby the thin film of bean curd skin was taken up by the face. Then a thin film of bean curd skin was formed by heating with the 500 W electric oven. These procedures were carried out five times using the 500 W electric oven, and the total yield and the period to form a film of bean curd skin were measured up to the fifth film. The results are shown in Table 5.

TABLE 5

| | total | total |
|---|---|---|
| | period | yield |
| | (sec) | (g) |
| 1st film | 50 | 1.74 |
| 2nd film | 90 | 3.34 |
| 3rd film | 141 | 5.16 |
| 4th film | 191 | 6.70 |
| 5th film | 221 | 8.56 |

### Example 11

100 ml of germination bean extract was filled into a polypropylene container (trade name: FT710 (produced by Ephpico Co.), 100 mm wide by 150 mm long) and heated by a 1200 W electric oven to form a film of bean curd skin. Then using a polypropylene container (70×100×20 mm) of a taking up device of which the face portion was wrapped, the resulting thin film of bean curd skin was attached to the wrapped face, thereby the thin film of bean curd skin was taken up by the face. These procedures were carried out five times, and the total yield and the period to form a film of bean curd skin were measured up to the fifth film. The results are shown in Table

TABLE 6

| | total | total |
|---|---|---|
| | period | yield |
| | (sec) | (g) |
| 1st film | 20 | 0.87 |
| 2nd film | 32 | 2.18 |
| 3rd film | 43 | 3.06 |
| 4th film | 59 | 4.44 |
| 5th film | 69 | 6.19 |

### Example 12

100 ml of germination bean extract was filled into a polypropylene container (trade name: FT710 (produced by Ephpico Co.), 100 mm wide by 150 mm long) and heated by a 1000 W electric oven to form a film of bean curd skin. Then using a polypropylene container (70×100×20 mm) of a taking up device of which the face portion was wrapped, the resulting thin film of bean curd skin was attached to the wrapped face, thereby the thin film of bean curd skin was taken up by the face. These procedures were carried out five times, and the total yield and the period to form a film of bean curd skin were measured up to the fifth film. The results are shown in Table 7.

TABLE 7

| | total | total |
|---|---|---|
| | period | yield |
| | (sec) | (g) |
| 1st film | 38 | 1.92 |
| 2nd film | 56 | 3.21 |
| 3rd film | 70 | 4.78 |
| 4th film | 84 | 6.21 |
| 5th film | 97 | 7.58 |

### Example 13

100 ml of germination bean extract was filled into a polypropylene container (trade name: FT710 (produced by Ephpico Co.), 100 mm wide by 150 mm long) and heated by a 500 W electric oven to form a film of bean curd skin. Then using a polypropylene container (70×100×20 mm) of a taking up device of which the face portion was wrapped, the resulting thin film of bean curd skin was attached to the wrapped face, thereby the thin film of bean curd skin was taken up by the face. These procedures were carried out five times, and the total yield and the period to form a film of bean curd skin were measured up to the fifth film. The results are shown in Table 8.

TABLE 8

| | total | total |
|---|---|---|
| | period | yield |
| | (sec) | (g) |
| 1st film | 138 | 2.00 |
| 2nd film | 188 | 3.79 |
| 3rd film | 218 | 5.34 |
| 4th film | 250 | 7.05 |
| 5th film | 300 | 8.83 |

In Example 9, the period to form the film of bean curd skin was relatively short, the eating feel was most soft, and thus the film of bean curd skin may suit the taste of consumers who like soft food of bean curd skin. In Example 13, the period to form the film of bean curd skin was relatively long, and the eating feel of the bean curd skin was firm. In Example 10 where 1500 W heating was carried out only at the initial stage, the initial heating period could be shortened compared to Example 13 where 500 W heating was carried out from the initial stage, and the period to produce five layers of bean curd skin could be shortened about 80 seconds. There was substantially no difference between eating feels of Examples 10 and 13.

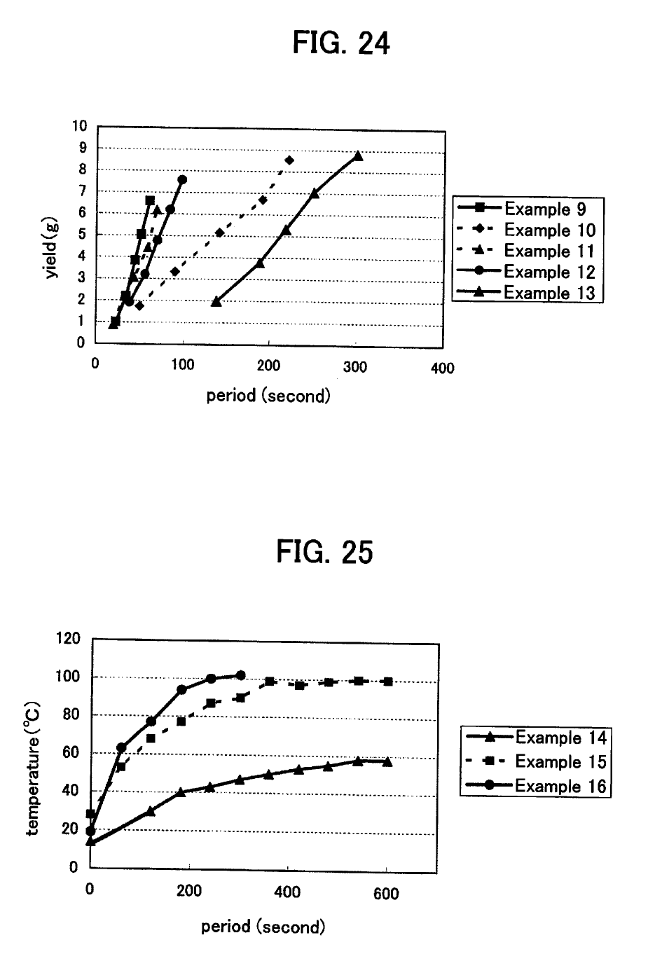

FIG. 24 shows a graph that represents a relation between the cumulative yield and the period in Examples 9 to 13. Example 10, where 1500 W heating was carried out, demonstrates that bean curd skin can be formed in a short period. The higher the heating energy the thinner and softer was the film, but the yield was not substantially different.

### Example 14

100 ml of bean extract (germination raw bean extract, produced in Nisshin OilliO Group Ltd.) was poured into a polypropylene container (170×100×30 mm, 0.5 mm thick, open upper face), and heated by a commercial microwave heating apparatus (produced by SANYO Electric Co., Ltd., microwave heating apparatus Model EM-1500T) equipped with a temperature sensor (by Anritsu Meter Co., fluorescence optical fiber thermometer FX8500) and heated at 200 W output to produce bean curd skin. The temperature of bean extract was measured after each heating period.

### Example 15

Temperature was measured in the same manner as Example 14 except that the output of the electric oven was changed to 300 W.

### Example 16

Temperature was measured in the same manner as Example 14 except that the output of the electric oven was changed to 400 W.

The results of Examples 14 to 16 are shown in Table 9 and FIG. 25. In Example 14, the temperature did not reach 60° C. even though the heating period was 10 minutes. In Example 15, the temperature rose to about 100° C. after 5 to 6 minutes, and in Example 16, the temperature rose to about 100° C. after 3 to 4 minutes. The bean curd skin produced in Example 14 was different from usual bean curd skin, and was gelatinous or pudding-like, insufficient in eating feel, and inferior in flavor. The bean curd skin of Examples 15, 16 heated at outputs 300 W or more can be appropriate in film formation and favorable in eating feel and favor, and 400 W or more can produce more favorable bean curd skin.

TABLE 9

| | Example 14 | Example 15 | Example 16 |
|---|---|---|---|
| period | temperature | temperature | temperature |
| sec | ° C. | ° C. | ° C. |
| 0 | 14 | 28 | 19 |
| 60 | — | 53 | 63 |
| 120 | 30 | 68 | 77 |
| 180 | 40 | 77 | 94 |
| 240 | 43 | 87 | 100 |
| 300 | 47 | 90 | 102 |
| 360 | 50 | 99 | — |
| 420 | 53 | 97 | — |
| 480 | 55 | 99 | — |
| 540 | 58 | 100 | — |
| 600 | 58 | 100 | — |

1. A method for producing bean curd skin, in which the bean curd skin is taken up as a thin film formed at a surface of a heated bean extract, comprising:
a step of forming a thin film, in which a bean extract is heated to form a thin film on the surface,
a step of attaching the thin film, in which a face portion of a taking up device is as a surface contacted the thin film thereby to make the face portion attach to the thin film, and
a step of taking up the thin film, in which the thin film is taken up by pulling up the taking up device attached to the thin film,
in which one cycle of the step of forming a thin film, the step of attaching the thin film, and the step of taking up the thin film is repeated for one or more cycles to form a monolayer or multilayer bean curd skin.

2. The method for producing bean curd skin according to claim 1, wherein the area of the face portion of the taking up device is smaller than the area of the thin film.

3. The method for producing bean curd skin according to claim 1 or 2, wherein the step of disposing an ingredient is further carried out to dispose the ingredient on the thin film formed at the surface of the heated bean extract between the step of forming a thin film and the step of attaching the thin film, when forming any layer of the second or later layer of the multilayer bean curd skin.

4. The method for producing bean curd skin according to claim 1, further comprising a step of packaging,
wherein a detachable detaching sheet is mounted to the face portion of the taking up device,
the detaching sheet is made to attach to the thin film in the step of attaching the thin film, and
the detaching sheet attached to the thin film is directly utilized as a part of packaging material in the step of packaging.

5. The method for producing bean curd skin according to claim 1, further comprising a step of peeling the thin layer,
wherein a peeling guide to peel the monolayer or multilayer bean curd skin from the taking up device is preliminarily mounted on at least a part of the vicinity of the periphery of the face portion of the taking up device,
the face portion having the peeling guide is made to attach to the thin film in the step of attaching the thin film, and
the thin film is then peeled from the face portion by way of separating the peeling guide from the taking up device or the taking up sheet, in the step of peeling the thin layer.

6. The method for producing bean curd skin according to claim 1, further comprising a step of peeling the thin layer,
wherein the face portion of the taking up device is formed by way of connecting two or more separable parts,
the face portion is made to attach to the thin film in the step of attaching the thin film, and
the thin film is then peeled from the face portion by way of separating the two or more separable parts, in the step of peeling the thin layer.

7. The method for producing bean curd skin according to claim 1, wherein the step of forming a thin film is carried out by use of an electric oven.

8. The method for producing bean curd skin according to claim 1, wherein all of the steps are carried out under a sterile atmosphere.

9. A method for producing bean curd skin, comprising heating bean extracts by use of an electric oven to form a thin film at the surface, then taking up the thin film,
wherein the output of the electric oven is no less than 300 W, and the bean extracts are heated to no lower than about the temperature at which the thin film forms at the surface of the bean extracts and no higher than the temperature at which the bean extracts initially boil.

10. Bean curd skin, produced by way of taking up a thin layer formed at surface of heated bean extracts, and folding inside the peripheral margin of the thin layer to form monolayer or multilayer bean curd skin.

11. The bean curd skin according to claim 10, wherein an ingredient is disposed between any layers of the multilayer bean curd skin.

12. A taking up device of bean curd skin, used for producing bean curd skin by way of taking up a thin layer formed at a surface of a heated bean extract,
wherein the taking up device comprises a face portion to as a surface contact the thin layer and a support portion to support the face portion.

13. The taking up device of bean curd skin according to claim 12, wherein the taking up device is of a box or ship shape of which the bottom face is the face portion.

14. The taking up device of bean curd skin according to claim 12 or 13, wherein the face portion of the taking up device is formed by way of connecting two or more separable parts.

15. A kit for producing bean curd skin, used for producing bean curd skin by way of taking up a thin film formed at a surface of a heated bean extract, comprising:
a taking up device of bean curd skin that comprises a face portion to as a surface contact the thin film and a support portion to support the face portion, and
a bean extract-injecting container that has an open portion to insert the face portion of the taking up device.

16. The kit for producing bean curd skin according to claim 15, wherein the taking up device is of a box or ship shape of which the bottom face is the face portion.

17. The kit for producing bean curd skin according to claim 15 or 16, wherein the shape of the bean extract-injecting container is designed so that the side wall stands approximately vertically.

18. The kit for producing bean curd skin according to claim 15, wherein the bean extract-injecting container is formed from a material that can be heated by an electric oven.

19. The kit for producing bean curd skin according to claim 15, further comprising a package of bean curd skin filled with bean curd skin.
